(19) United States
(12) Patent Application Publication
(10) Pub. No.: US 2026/0218787 A1
(43) Pub. Date: Jul. 30, 2026

(54) REDUCTION GEARBOX AND BOX BODY OF REDUCTION GEARBOX

(71) Applicant: YANTAI JEREH OILFIELD SERVICES GROUP CO., LTD., Yantai (CN)

(72) Inventors: Junlei YAO, Yantai (CN); Xueqing GAO, Yantai (CN); Maoqin LI, Yantai (CN); Mengran WANG, Yantai (CN)

(73) Assignee: YANTAI JEREH OILFIELD SERVICES GROUP CO., LTD., Yantai (CN)

(21) Appl. No.: 19/572,541

(22) Filed: Mar. 19, 2026

Related U.S. Application Data
(63) Continuation of application No. PCT/CN2024/136320, filed on Dec. 3, 2024.

(30) Foreign Application Priority Data
May 28, 2024 (CN) 202410671711.5
May 28, 2024 (CN) 202410674747.9
May 28, 2024 (CN) 202421182665.4
May 28, 2024 (CN) 202421187858.9

(51) Int. Cl. F16H 57/021; F16H 57/04

(52) U.S. Cl. CPC F16H 57/021; F16H 57/0424

(57) ABSTRACT

The present disclosure relates to a box body of a reduction gearbox, comprising an input side box body (2), a lateral box body (3), and an output side box body (4), wherein the input side box body (2) and the output side box body (4) are connected to the lateral box body (3) through a plurality of bolts (9). The input side box body is provided with a first bearing pedestal (20), a second bearing pedestal (20), and a plurality of radial ribbed slabs (5). The plurality of radial ribbed slabs (5) comprise a plurality of first radial ribbed slabs (5) and a plurality of second radial ribbed slabs (5), the first radial ribbed slabs (5) radially extending outward from a circle center of the first bearing pedestal (20), and the second radial ribbed slabs (5) radially extending outward from a circle center of the second bearing pedestal (20).

### CROSS-REFERENCE TO RELATED APPLICATIONS

This application is a continuation of and claims the benefit of priority to PCT Application No. PCT/CN2024/136320, filed Dec. 3, 2024, and entitled GEARBOX HOUSING AND BOX BODY REDUCTION GEARBOX, which is based on and claims the benefit of priority to Chinese Patent Application No. 202421187858.9 filed on May 28, 2024, Chinese Patent Application No. 202410671711.5 file on May 28, 2024, Chinese Patent Application No. 202410674747.9 filed on May 28, 2024, and Chinese Patent Application No. 202421182665.4 filed on May 28, 2024.” The above applications are incorporated herein by reference in their entireties.

### TECHNICAL FIELD

The present disclosure relates to a reduction gearbox in fracturing equipment and a box body of the reduction gearbox, and particularly, a reduction gearbox having an oil return port.

### BACKGROUND

A reduction gearbox is a critical transmission system of mechanical equipment such as fracturing equipment. The reduction gearbox is connected between a crankcase and a power input of an engine. Converted power is transmitted to the crankcase by designing different speed changes by a gear inside the reduction gearbox, thereby achieving deceleration and torque increase or acceleration and torque decrease, and providing different transmission capabilities for the fracturing equipment.

However, during operation of the reduction gearbox, the reduction gearbox may generate continuously violent vibration due to various impacts such as gear meshing, a torsional vibration of a shaft system, and a vibration of a fracturing pump box body. Therefore, a box body of the entire reduction gearbox needs to have sufficient rigidity and buffering and vibration-absorbing performance in terms of a material, a structure, and a construction mode, so as to maximally absorb and buffer vibrations inside the reduction gearbox, thereby preventing wear and damage of key components such as gears, racks, and bearings.

A steel plate welded box body is usually used in the reduction gearbox in the existing technology. However, welding is a local rapid heating and cooling process, and a molten metal in a welding region is bound by a body metal material around and cannot freely expand and retract. Therefore, the molten metal may be subject to a pulling stress from the body metal material in the cold retraction process, and an unmolten metal material around a weld seam may be non-uniformly distributed under the action of welding heat cycle.

Stress generated by a distribution change cannot be eliminated in such systems, so that the stress easily becomes a source of a fatigue crack of the box body, and expands into an extensible crack under a cyclic alternating stress and impact vibration of the reduction gearbox, causing a problem of shortening a service life of the reduction gearbox.

In addition, a cast box body of the reduction gearbox is generally a thin-walled box body, and it is very difficult to resist a meshing impact transmitted by the gear to a bearing pedestal and the box body by merely depending on connection between the box body and the bearing pedestal. In addition, because of low rigidity and strength of a cast flat plate structure, the flat plate structure easily deforms under a longstanding alternating load, causing an eccentric wear and a transmission mismatch of the gear and the bearing, and finally causing damage to the internal transmission system and the external cast box body.

Furthermore, the box body of the conventional reduction gearbox is heavy, which not only increases the casting costs, but also is extremely inconvenient for mounting, maintenance, and transportation.

In addition, when a transmission ratio of a parallel-level reduction gearbox is large, a difference between a diameter of an input gear and a diameter of an output gear is large, and an appearance of a housing surrounding the parallel-level reduction gearbox is also inharmonious due to a relatively large size difference. As a result, the overall appearance of the reduction gearbox is dull and clumsy.

The reduction gearbox is usually classified into a planetary and parallel-level reduction gearbox and a single-parallel-level reduction gearbox. While the existing fracturing equipment uses the single-parallel-level reduction gearbox, to increase the power, a double-sided single-parallel-level reduction gearbox driving mode may be used. A working principle thereof is that one side of an engine performs driving and is connected to the reduction gearbox, and the reduction gearbox on this side is connected to and driven by a reduction gearbox on the other side through a bottom transmission shaft. A reduction gearbox assembly may be composed of a parallel-level reduction gearbox and a planetary-level reduction gearbox. A parallel-level interface and a planetary-level interface use standardized flanges and spline structures, so that the same planetary-level structure is quickly matched to switch parallel-level reduction gearboxes with different speed ratios, thereby achieving switching between different speed ratios.

A lubrication system that can provide lubricating oil is arranged in the reduction gearbox. During operation of the reduction gearbox, a large amount of lubricating oil needs to be circulated into key friction contact points. A lubricating oil film is formed on a contact surface, to avoid dry friction between rotary transmission parts. In addition, a large amount of heat is brought away or removed from the system in the circulation process. This facilitates system heat dissipation.

Common lubrication modes include splash (oil immersion) lubrication and forced lubrication. For the splash (oil immersion) lubrication, this lubrication mode is to sink or partially sink a rotating gear into lubricating oil of a housing, and splash oil onto another gear and a bearing for lubrication. Therefore, the structure is simple, the costs are relatively low, and maintenance is convenient. The disadvantage is that for a high-speed gearbox, this mode cannot provide a timely and sufficient cooling effect. If an oil level is increased to achieve a cooling effect, an excessively high oil level increases the resistance to the viscosity of the lubricating oil on the gear, and also increases a power loss caused by the pumping action of gear meshing on the lubricating oil.

The forced lubrication mode is usually used for the high-speed reduction gearbox. An oil pressure is generated by using an oil pump, and oil is introduced to a surface of a friction pair. An oil amount may be determined according to heat that needs to be removed. This mode avoids a churning loss, and can achieve filtering, cooling, and monitoring during the circulation of the oil. However, the disadvantage is that an oil channel needs to be designed to guide the oil, so that the lubrication system is complex, and maintenance is difficult.

The reduction gearbox can also be integrated with the advantages of the foregoing two modes according to its design. In a case of meeting a lubrication requirement, the splash (oil immersion) lubrication mode and/or the forced lubrication mode is selected. The forced lubrication mode is selected for a lightweight reduction gearbox. Since the lightweight reduction gearbox is simple in structure and has a few of lubricating points, the forced lubrication mode is selected. An oil channel is simple in design and convenient to maintain, and has a low oil demand. The oil channel and main equipment (e.g. a fracturing pump) can share an oil pump with a filter, without separately providing another oil pump. The splash (oil immersion) lubrication and the forced lubrication are selected for the medium-and high-speed reduction gearboxes. Oil at a level is stored at a bottom of a housing of the reduction gearbox. The oil stored at the bottom is splashed to a desired position with rotation of the gear/the bearing, to bring away heat, thereby making up for a shortage of forced lubrication oil and cooling. In addition, since the splash (oil immersion) lubrication is auxiliary, the oil level need not be excessively high here.

An oil return port is usually provided in a box body of the reduction gearbox due to the lubricating oil provided by the lubrication system of the reduction gearbox. A proper design layout of the oil return port on the box body of the reduction gearbox can achieve smooth circulation of the lubricating oil, and prevent generation of heat by oil accumulation caused by poor oil return in the box body and by gear churning.

In either the parallel-level and planetary-level two-stage reduction gearbox or the single-parallel-level reduction gearbox, the oil return port for the lubricating oil is provided in a bottom of the box body of the parallel-level reduction gearbox. The design of the oil return port in the existing technology has a problem that oil return is not smooth enough.

### SUMMARY

### Technical Problems to Be Solved

For the above problems of a welded box body, the present disclosure provides a box body of a reduction gearbox, which has beneficial effects of restraining deformation of the box body, improving the support stiffness of the box body, assisting in heat dissipation of the reduction gearbox.

In addition, the present disclosure provides a box body of a reduction gearbox, which can reduce a weight of the reduction gearbox and improve the appearance of the box body.

In addition, the present disclosure aims to provide a reduction gearbox having a novel oil return port structure, which can improve discharging of lubricating oil through an oil return port, for making oil return smooth, thereby preventing generation of heat by oil accumulation caused by poor oil return in the box body of the reduction gearbox and by gear churning.

### Technical Solutions Adopted to Solve the Technical Problems

A first aspect of the present disclosure provides a box body of a reduction gearbox, including an input side box body, a lateral box body, and an output side box body; the input side box body and the output side box body are connected to the lateral box body through a plurality of bolts arranged along the lateral box body; the input side box body is provided with a first bearing pedestal, a second bearing pedestal, and a plurality of radial ribbed slabs; the plurality of radial ribbed slabs include a plurality of first radial ribbed slabs and a plurality of second radial ribbed slabs; the first radial ribbed slabs radially extend outward from a circle center of the first bearing pedestal, and the second radial ribbed slabs radially extend outward from a circle center of the second bearing pedestal; the radial ribbed slabs are connected to the bolts; a direction in which the circle center of the first bearing pedestal is connected to the circle center of the second bearing pedestal is a first direction, and a second direction is perpendicular to the first direction; by using the circle center of the first bearing pedestal a center, in a region deviating from the second direction by a pressure angle of ±30°, the first radial ribbed slabs and the bolts are arranged more densely than in another region; and the pressure angle is a pressure angle of a pressure on the first bearing pedestal.

In another aspect of the present disclosure, in the region, an angle between the first radial ribbed slabs is 15° to 25°.

In another aspect of the present disclosure, built-in oil paths integrally formed with the box body are arranged in the radial ribbed slabs forming an angle of 0° to 30° with the second direction.

In another aspect of the present disclosure, two side surfaces, which are perpendicular to a surface of the input side box body, of the radial ribbed slabs are arranged in parallel or a distance between the two side surfaces gradually decreases towards the lateral box body.

In another aspect of the present disclosure, a connection point between each first radial ribbed slab and the first bearing pedestal is a first connection point; a height from the first connection point to a surface of the box body is a first height; a connection point between the first radial ribbed slab and each bolt is a second connection point; a height from the second connection point and the surface of the box body is a second height; a third height from the first radial ribbed slab to the surface of the box body is set as follows:
i. when a difference between the first height and the second height is less than or equal to 5 mm, the third height is a smaller value of the first height and the second height; and
ii. when a difference between the first height and the second height is greater than 5 mm and less than or equal to 20 mm, the third height is the first height between the first connection point and a turning point; between the turning point and the second connection point, a top surface of the first radial ribbed slab tilts relative to the input side box body, so that the third height linearly decreases from the first height to the second height,
where the turning point is located between the first connection point and the connection point; and
iii. when a difference between the first height and the second height is greater than 20 mm, the top surface of the first radial ribbed slab tilts relative to the input side box body, so that the third height linearly decreases from the first height to the second height.

In another aspect of the present disclosure, a length between the turning point and the second connection point is ⅕ to ⅓ of a length of the first radial ribbed slab.

In another aspect of the present disclosure, when the difference between the first height and the second height is greater than 5 mm and less than or equal to 20 mm, a tilting angle of the first radial ribbed slab relative to the input side box body is in a range of 2° to 10°, and where when the difference between the first height and the second height is greater than 20 mm, a tilting angle of the first radial ribbed slab relative to the input side box body is in a range of 2° to 15°.

In another aspect of the present disclosure, the box body of the reduction gearbox further includes: a plurality of peripheral ribbed slabs, where the plurality of peripheral ribbed slabs intersect with the radial ribbed slabs, to connect the plurality of radial ribbed slabs to each other, where the peripheral ribbed slabs are configured to vertically intersect with the radial ribbed slabs, or the peripheral ribbed slabs are configured to surround the circle center of the first bearing pedestal and the circle center of the second bearing pedestal along the lateral box body.

In another aspect of the present disclosure, first openings are provided in regions surrounded by the peripheral ribbed slabs and the radial ribbed slabs.

In another aspect of the present disclosure, ribbed slab skirts are arranged on portions of the peripheral ribbed slabs along the first openings and portions of the radial ribbed slabs along the first openings; and a width of each ribbed slab skirt is 1 to 5 times of a thickness of the input side box body or the output side box body.

In another aspect of the present disclosure, the box body of the reduction gearbox further includes: a horizontal ribbed slab, where the horizontal ribbed slab is arranged in a region between two tangent lines of the first bearing pedestal and the second bearing pedestal; the horizontal ribbed slab includes a first horizontal ribbed slab and a second horizontal ribbed slab; the first horizontal ribbed slab is located on a connection line between the circle center of the first bearing pedestal and the circle center of the second bearing pedestal; and the second horizontal ribbed slab is symmetrically arranged by using the first horizontal ribbed slab as a reference.

In another aspect of the present disclosure, an angle between the first horizontal ribbed slab and the second horizontal ribbed slab is 0° to 10°, and a weight-reducing groove is provided between the first horizontal ribbed slab and the second horizontal ribbed slab.

In another aspect of the present disclosure, a thickness of the horizontal ribbed slab is 1.5 to 3 times of a thickness of the input side box body or the output side box body.

In another aspect of the present disclosure, the box body of the reduction gearbox further includes: a plurality of vertical ribbed slabs, where the vertical ribbed slabs are arranged in the second direction and are connected to the bolts.

In another aspect of the present disclosure, the radial ribbed slabs are connected to the vertical ribbed slabs, to form triangular structures with the horizontal ribbed slab.

In another aspect of the present disclosure, the box body of the reduction gearbox further includes: a plurality of axial ribbed slabs, where the axial ribbed slabs are arranged inside the lateral box body and are perpendicular to the input side box body and the output side box body; one end of each axial ribbed slab is connected to each bolt, and the other end is connected to each radial ribbed slab through a turning ribbed slab located at a connection position between the lateral box body and the output side box body.

In another aspect of the present disclosure, sealing structures are included in mating faces of the input side box body and/or the output side box body and the lateral box body, and the sealing structures at least include sealing members.

In another aspect of the present disclosure, a cross section of each radial ribbed slab is rectangular.

In another aspect of the present disclosure, a thickness of each second radial ribbed slab is 2 to 5 times of a thickness of the output end box body.

In another aspect of the present disclosure, by using the circle center of the second bearing pedestal as the center, in the region deviating from the second direction by the pressure angle of ±30°, the second radial ribbed slabs and the bolts are arranged more densely than in another region.

A first aspect of the present disclosure provides a box body of a reduction gearbox, including an input side box body, a lateral box body, and an output side box body; the input side box body and the output side box body are connected to the lateral box body; the input side box body is provided with a first bearing pedestal, a second bearing pedestal, and a plurality of peripheral ribbed slabs, and in a direction from a circle center of the first bearing pedestal to an outer peripheral edge of the lateral box body, the input side box body is formed into a step-like structure having a plurality of step portions; the peripheral ribbed slabs are at least partially formed on the step portions, and are configured to: (i) surround the circle center of the first bearing pedestal or a circle center of the second bearing pedestal, or (ii) surround the circle center of the first bearing pedestal and the circle center of the second bearing pedestal along the lateral box body.

In another aspect of the present disclosure, a height of each step portion is 0.5 to 2 times of a thickness of the input side box body.

In another aspect of the present disclosure, spacings between the step portions are equal to each other or different from each other.

In another aspect of the present disclosure, the box body of the reduction gearbox further includes: a plurality of radial ribbed slabs, where the radial ribbed slabs extend radially outward from the circle center of the first bearing pedestal and intersect with the peripheral ribbed slabs; the radial ribbed slabs are alternately formed by horizontal planes and inclined planes; the horizontal planes are parallel to an extension plane of the output side box body; and the inclined planes are formed on planes where the step portions intersect with the extension plane.

In another aspect of the present disclosure, an angle between each inclined plane and each horizontal plane is less than 45°.

In another aspect of the present disclosure, openings are provided in regions surrounded by the peripheral ribbed slabs and the radial ribbed slabs.

In another aspect of the present disclosure, the box body of the reduction gearbox further includes: a plurality of bolts; the bolts are arranged along the lateral box body and connect the input side box body and the output side box body to the lateral box body, where the radial ribbed slabs are connected to the bolts.

In another aspect of the present disclosure, the box body of the reduction gearbox further includes: a horizontal ribbed slab, where the horizontal ribbed slab is arranged in a region between two tangent lines of the first bearing pedestal and the second bearing pedestal; the horizontal ribbed slab includes a first horizontal ribbed slab and a second horizontal ribbed slab; the first horizontal ribbed slab is located on a connection line between the circle center of the first bearing pedestal and the circle center of the second bearing pedestal; and the second horizontal ribbed slab is symmetrically arranged by using the first horizontal ribbed slab as a reference.

In another aspect of the present disclosure, the box body of the reduction gearbox further includes: a plurality of vertical ribbed slabs; the vertical ribbed slabs are arranged in a direction perpendicular to the horizontal ribbed slab and are connected to the bolts, where the radial ribbed slabs are connected to the vertical ribbed slabs, to form triangular structures with the horizontal ribbed slab.

Another aspect of the present disclosure provides a box body of a reduction gearbox, including an input side box body, a lateral box body, and an output side box body, where the input side box body and the output side box body are connected to the lateral box body; the input side box body is provided with a first bearing pedestal, a second bearing pedestal, and a plurality of vertical ribbed slabs, and in a direction from a circle center of the first bearing pedestal to a circle center of the second bearing pedestal, the input side box body is formed into a step-like structure having a plurality of first step portions; and the vertical ribbed slabs are formed on a connection line perpendicular to the circle center of the first bearing pedestal and the circle center of the second bearing pedestal, and are at least partially formed on the first step portions.

In another aspect of the present disclosure, the box body of the reduction gearbox further includes: a plurality of bolts; the bolts are arranged along the lateral box body and connect the input side box body and the output side box body to the lateral box body, where the vertical ribbed slabs are connected to the bolts.

In another aspect of the present disclosure, a height of the step-like structure gradually decreases in the direction from the circle center of the first bearing pedestal to the circle center of the second bearing pedestal.

In another aspect of the present disclosure, a third bearing pedestal, a fourth bearing pedestal, and a plurality of peripheral ribbed slabs are arranged on the output side box body; the third bearing pedestal is opposite to the first bearing pedestal, and the fourth bearing pedestal is opposite to the second bearing pedestal; in a direction from a circle center of the fourth bearing pedestal to a circle center of the third bearing pedestal, the output side box body is formed into a step-like structure having a plurality of second step portions; the peripheral ribbed slabs are at least partially formed on the second step portions; the peripheral ribbed slabs are configured to: (i) surround the circle center of the third bearing pedestal or the circle center of the fourth bearing pedestal, or (ii) surround the circle center of the third bearing pedestal and the circle center of the fourth bearing pedestal along the lateral box body.

In another aspect of the present disclosure, a height of the step-like structure on the output side box body gradually decreases in the direction from the circle center of the first bearing pedestal to the circle center of the second bearing pedestal.

In another aspect of the present disclosure, the box body of the reduction gearbox further includes: a plurality of radial ribbed slabs, where the radial ribbed slabs extend radially outward from the circle center of the first bearing pedestal and the circle center of the second bearing pedestal and are connected to the bolts.

In another aspect of the present disclosure, the box body of the reduction gearbox further includes: a horizontal ribbed slab, where the horizontal ribbed slab is arranged in a region between two tangent lines of the first bearing pedestal and the second bearing pedestal; the horizontal ribbed slab includes a first horizontal ribbed slab and a second horizontal ribbed slab; the first horizontal ribbed slab is located on a connection line between the circle center of the first bearing pedestal and the circle center of the second bearing pedestal; and the second horizontal ribbed slab is symmetrical relative to the first horizontal ribbed slab.

In another aspect of the present disclosure, the radial ribbed slabs are connected to the vertical ribbed slabs, to form triangular structures with the horizontal ribbed slab.

In another aspect of the present disclosure, a width of each radial ribbed slab gradually decreases in a direction where the circle center of the first bearing pedestal and the circle center of the second bearing pedestal are outward.

In another aspect of the present disclosure, a thickness of the box body in a region between two tangent lines of the first bearing pedestal and the second bearing pedestal is greater than a thickness of another region.

In another aspect of the present disclosure, by respectively using the circle center of the first bearing pedestal and the circle center of the second bearing pedestal as centers, a width of each radial ribbed slab in a region deviating from the vertical ribbed slabs by a pressure angle of ±30° is set to 1.1 to 2 times of a width of each radial ribbed slab in another region, and the pressure angle is a pressure angle of a pressure on the first bearing pedestal.

A first aspect of the present disclosure provides a box body of a reduction gearbox, including an input side box body, a lateral box body, and an output side box body. The input side box body and the output side box body are connected to the lateral box body; the input side box body is provided with a first bearing pedestal and a second bearing pedestal; the lateral box body is composed of a first circular-arc portion, a second circular-arc portion, and two linear portions; the two linear portions are tangent to the first circular-arc portion and the second circular-arc portion; and a circle center of the first circular-arc portion overlaps a circle center of the first bearing pedestal.

Another aspect of the present disclosure provides a box body of a reduction gearbox, including an input side box body, a lateral box body, and an output side box body. The input side box body and the output side box body are connected to the lateral box body; the input side box body is provided with a first bearing pedestal and a second bearing pedestal; the lateral box body is composed of a first circular-arc portion, a second circular-arc portion, and two linear portions; the two linear portions are tangent to the first circular-arc portion and the second circular-arc portion; a first circle center of the first circular-arc portion is located on a connection line between a second circle center of the first bearing pedestal and a third circle center of the second bearing pedestal.

In another aspect of the present disclosure, a radius of the first circular-arc portion is 1.2 to 1.8 times of a radius of a gear supported by the first bearing pedestal.

In another aspect of the present disclosure, a distance between the first circle center and the second circle center is between 50 mm and 150 mm.

Another aspect of the present disclosure provides a box body of a reduction gearbox, including an input side box body, a lateral box body, and an output side box body. The input side box body and the output side box body are connected to the lateral box body; the input side box body is provided with a first bearing pedestal and a second bearing pedestal; and in a front view, in a horizontal direction of a connection line between a first circle center of the first bearing pedestal to a second circle center of the second bearing pedestal, the lateral box body has a first straight line in a vertical direction perpendicular to the horizontal direction.

In another aspect of the present disclosure, in the front view, the lateral box body has a second straight line segment parallel to the horizontal direction; and the second straight line segment overlaps the second circle center in the vertical direction.

To achieve the foregoing objective, according to an aspect of the present disclosure, the inventor develops a reduction gearbox, which includes: a box body; and an oil return port, where the oil return port is provided in on a wall of a bottom of the box body and is configured to discharge lubricating oil inside the box body; the oil return port has an oil baffle plate, an oil return through hole, and a cambered transition portion; the oil baffle plate and the cambered transition portion are arranged on two opposite sides of the oil return through hole; and the oil baffle plate is raised from the wall of the bottom of the box body to the inside of the box body.

Further, the reduction gearbox further includes one or more auxiliary oil return ports, and each auxiliary oil return port is arranged at a position, which is different from the oil return port, on the box body.

Further, the oil return port is sunken relative to the box body.

Further, the oil return port and the wall of the bottom of the box body are entirely sunken.

Further, the oil return port is outwards partially sunken in a range that uses a center of the oil return through hole as a circle center and uses 1 to 3 times of a wall thickness of the box body as a diameter.

Further, a height of the sinking is 1 to 5 times of the wall thickness of the box body.

Further, a transition portion that smoothly transitions in a throwing direction of the lubricating oil exists between the oil return port and a housing of the box body when the oil return port is sunken relative to the box body.

Further, the reduction gearbox further includes a gear apparatus arranged inside the box body; and an angle between the transition portion and a tangent line direction of an addendum circle of the gear apparatus is 0° to 20°.

Further, the reduction gearbox further includes a gear apparatus arranged inside the box body; and a height of the oil baffle plate is set to be as high as possible without interfering with the gear apparatus.

Further, the oil return through hole is circular, polygonal, or elliptical.

Further, the oil baffle plate is integrally formed with the box body.

### Beneficial Effects

According to one aspect of the present disclosure, a box body of a reduction gear box is provided, which has the beneficial effects of restraining deformation of the box body, improving the support stiffness of the box body, assisting in heat dissipation of the reduction gearbox, and the like, and can further reduce the weight of the reduction gearbox and improve the appearance of the box body.

In addition, according to the present disclosure, a distance between the oil return port and the addendum circle of the gear apparatus is increased, which helps lubricating oil to settle and leak, so that the lubricating oil can be smoothly discharged, thereby preventing generation of heat by oil accumulation caused by poor oil return in the box body of the reduction gearbox and by gear churning, and improving the overall functionality of the reduction gearbox.

### BRIEF DESCRIPTION OF THE DRAWINGS

FIG. 1 shows an example three-dimensional view sectioned along a box body of a reduction gearbox.

FIG. 2 shows an example arrangement mode of radial ribbed slabs on a left box body and analysis of force-bearing types and directions of bearing pedestals during gear meshing.

FIG. 3 shows an example force-bearing analysis and pressure angle annotation of a gear meshing point, to describe a reason why ribbed slabs and bolts are densely arranged in a key force-bearing region.

FIG. 4 is an example structural diagram of embedding a built-in oil path in a radial ribbed slab.

FIG. 5A and FIG. 5B show an example shape of a radial ribbed slab in a front view, and FIG. 5C shows an example cross-sectional view of a box body to describe a distance between a bearing pedestal and a surface of the box body.

FIG. 6 to FIG. 8B show example height designs of radial ribbed slabs in different cases.

FIG. 9A and FIG. 9B show an example structure of peripheral ribbed slabs on a left box body.

FIG. 10 shows another example structure of radial ribbed slabs and peripheral ribbed slabs on a right box body.

FIG. 11 shows an example specific structure of a horizontal ribbed slab.

FIG. 12 shows example structures of an axial ribbed slab and a turning ribbed slab.

FIG. 13 shows an example sealing structure in a mating face of a box body.

FIG. 14A and FIG. 14B show different example cross-sectional shapes of a ribbed slab.

FIG. 15A and FIG. 15B show an example step-like structure of a parallel-level box body of a parallel-level+ planetary-level reduction gearbox.

FIG. 16A and FIG. 16B show an example step-like structure of a box body of a single-parallel-level reduction gearbox.

FIG. 17 is an example three-dimensional diagram sectioned along a box body of a reduction gearbox according to the present disclosure.

FIG. 18 exemplarily shows an example front view of a first contour structure of a box body in the present disclosure.

FIG. 19 exemplarily shows an example front view of a second contour structure of a box body in the present disclosure.

FIG. 20 exemplarily shows an example front view of a third contour structure of a box body in the present disclosure.

FIG. 21 is an example schematic diagram of a reduction gearbox according to an example of the present disclosure.

FIG. 22 is an example enlarged view of an oil return port in FIG. 21.

FIG. 23 is an example schematic diagram of a reduction gearbox according to another example of the present disclosure, showing an oil return port that is entirely sunken.

FIG. 24 is an example schematic diagram of a reduction gearbox according to another example of the present disclosure, showing an oil return port that is partially sunken.

FIG. 25 is an example enlarged view of the oil return port that is partially sunken in FIG. 24.

FIG. 26 is an example schematic diagram of a reduction gearbox according to another example of the present disclosure, showing an oil return port that is partially sunken.

FIG. 27 is an example enlarged view of the oil return port that is partially sunken in FIG. 26.

FIG. 28 is an example schematic diagram of a reduction gearbox according to another example of the present disclosure, showing an oil return port that is seen from the inside of a box body of the reduction gearbox.

FIG. 29 is an example enlarged view of an oil return port in FIG. 28.

FIG. 30 is an example schematic diagram of the reduction gearbox of FIG. 28, showing an oil return port that is seen from the outside of the box body of the reduction gearbox.

FIG. 31 is an example enlarged view of the oil return port in FIG. 30.

### DETAILED DESCRIPTION

To make the objectives, technical solutions, and advantages of the embodiments of the present disclosure clearer, the technical solutions in the embodiments of the present disclosure are described below with reference to the accompanying drawings in the embodiments of the present disclosure. Apparently, the described embodiments are merely some embodiments of the present disclosure, rather than all of the embodiments. All other embodiments obtained by a person of ordinary skill in the art through the described embodiments of the present disclosure without making creative efforts shall fall within the protection scope of the present disclosure.

The following provides a detailed explanation of the technical solutions disclosed in the embodiments of the present disclosure in conjunction with the accompanying drawings. For the sake of simplicity, reference numerals of components may not necessarily be shown in all figures. Usually, for the purpose of emphasis, in some accompanying drawings, only reference numerals of relevant components described with reference to the accompanying drawings in this specification are shown, and relevant numerals of other components are omitted. However, the same reference numerals are universal for the same components in different accompanying drawings.

Unless otherwise defined, technical or scientific terms used in the present disclosure should have the ordinary meanings as understood by those of ordinary skill in the art to which the present disclosure belongs. For example, terms “horizontal”, “vertical”, and the like used in the present disclosure do not represent absolute directions, but only describe directions commonly used in reduction gearboxes. The term “include”, “contain”, or another other similar term means that the elements or objects stated before them encompass the elements or objects and equivalents thereof listed after them, but do not exclude other elements or objects. The terms “upper”, “lower”, “left”, “right”, and the like are merely used to indicate relative positional relationships. After the absolute position of a described object changes, the relative positional relationship may alternatively change correspondingly.

First, the following describes, by using the following sequence, a box body of a reduction gearbox, a reduction gearbox, and related features of the present disclosure.
I. First embodiment of a box body of a reduction gearbox according to the present disclosure
1. Summary of a box body of a reduction gearbox
2. Setting of ribbed slabs of a box body of a reduction gearbox
2.1 Radial ribbed slab and bolt
2.2 Peripheral ribbed slab
2.3 Horizontal ribbed slab
2.4 Vertical ribbed slab
2.5 Axial ribbed slab
2.6 Sealing structure
2.7 Shape of ribbed slab
3. Step-like arrangement of a box body of a reduction gearbox
3.1 Step-like arrangement of a parallel-level+planetary-level reduction gearbox
3.2 Stepped deployment of single-parallel-level reduction gearboxes
II. Second embodiment of a box body of a reduction gearbox according to the present disclosure
III. Embodiment of a box body of a reduction gearbox according to the present disclosure

The foregoing content is described below with reference to the accompanying drawings and reference signs.

### I. First Embodiment of a Box Body of a Reduction Gearbox According to the Present Disclosure

### 1. Summary of a Box Body of a Reduction Gearbox

Various wheel assemblies, bearing assemblies, lubrication systems, connectors, and the like are mounted in a box body of a reduction gearbox, and are connected to the outside by using connection flanges.

Usually, the reduction gearbox can be classified into a parallel-level+pedestrian-level reduction gearbox and a single-parallel-level reduction gearbox.

In the parallel-level+ pedestrian-level reduction gearbox, parallel-level gears include a small gear which serves as an input end, and a large gear meshed with the small gear. A bearing pedestal for supporting a bearing of the small gear and a bearing pedestal for supporting a bearing of the large gear are further arranged on the box body of the reduction gearbox. The bearing pedestal of the small gear is arranged in parallel to the bearing pedestal of the large gear. In addition, the large gear is meshed with a planetary-level gear serving as an output end to transmit power. The box body for accommodating the parallel-level gears is connected to a connection flange through planetary-level gears.

In the single-parallel-level reduction gearbox, parallel-level gears include a small gear which serves as an input end, and a large gear meshed with the small gear. A bearing pedestal for supporting a bearing of the small gear and a bearing pedestal for supporting a bearing of the large gear are further arranged on the box body of the reduction gearbox. The bearing pedestal of the small gear is arranged in parallel to the bearing pedestal of the large gear. The box body for accommodating the parallel-level gears is integrated with a connection flange. Input and output interfaces of the two types of box bodies have the same forms, so that they are interchangeable in the same platform.

In the present disclosure, the parallel-level+planetary-level reduction gearbox is mainly used as an example for description, and the box body of the reduction gearbox is formed in a manner of integral casting forming, or is formed in a manner of combining steel plate welding and casting. In a case that the box body has sufficient support stiffness and strength, any cast iron or cast steel material can be selected.

### 2. Setting of Ribbed Slabs of a Box Body of a Reduction Gearbox

FIG. 1 shows a three-dimensional view sectioned along a box body 1 of a reduction gearbox. This three-dimensional view is sectioned along a connection line of circle centers of two bearing pedestals.

As shown in FIG. 1, the box body 1 of the reduction gearbox includes a left box body 2 located on an input end of the reduction gearbox, a lateral box body 3, and a right box body 4 located on an output end of the reduction gearbox. The left box body 2, the right box body 4, and the lateral box body 3 are connected through bolts 9 arranged along an outer edge of the box body. Surface ribbed slabs having different directions are respectively arranged on the left box body 2 and the right box body 4, and the surface ribbed slabs include, for example, radial ribbed slabs 5, peripheral ribbed slabs 6, horizontal ribbed slabs 7, vertical ribbed slabs 8, and the like.

In the following descriptions, a horizontal direction means a direction of a connection line between a circle center of the bearing pedestal of large gear and a circle center of the bearing pedestal of the small gear in the parallel-level reduction gearbox (the horizontal direction is a first direction in the present disclosure), and a vertical direction means a direction perpendicular to the connection line (the vertical direction is a second direction in the present disclosure).

The ribbed slabs arranged on the box body 1 of the reduction gearbox can enable the box body to obtain higher strength and stiffness, so as to bear a high vibration impact and a large torque, effectively restrain deformation of the box body 1 of the reduction gearbox during operation, improve the support stiffness of the box body on the premise of adding a minimum material weight and ensuring that a transmitted torque is unchanged, implement a lightweight design, prevent eccentric wear and a transmission error of the gears and the bearings caused by deformation of the box body, and reduce noise.

In addition, various ribbed slabs arranged outside the box body can effectively enlarge a surface area of the box body, which helps the reduction gearbox to rapidly dissipate heat.

In addition, connection between the ribbed slabs and a flat-plate end surface can effectively improve the flowing property of molten iron during casting. The ribbed slabs can serve as an internal flow path of the thin-walled flat-plate end surface, which facilitates filling of a cavity and can effectively avoid generation of internal defects of a thin-walled cast box body.

Each type of surface ribbed slab is described in detail below with reference to the accompanying drawings.

### 2.1 Radial Ribbed Slab and Bolt

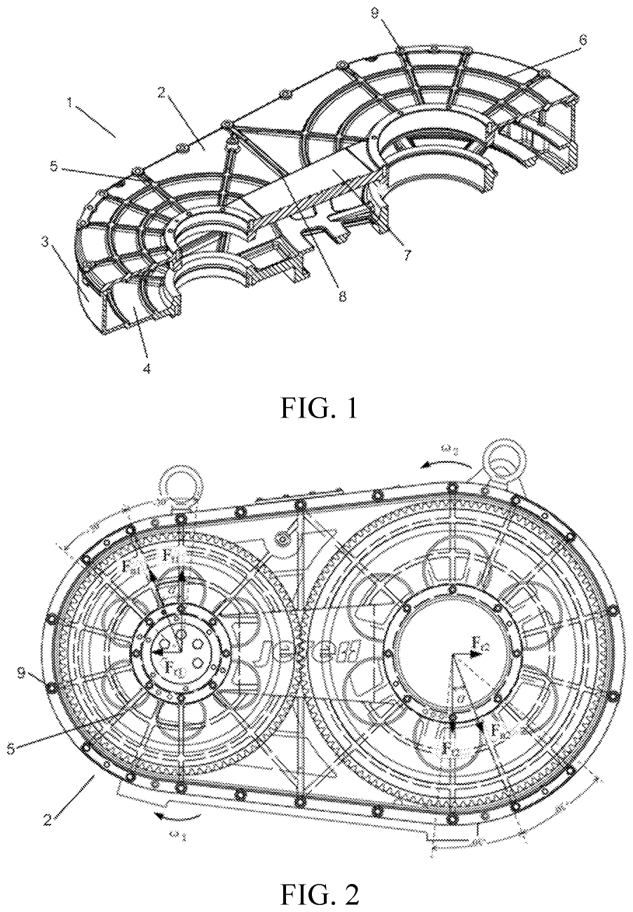

FIG. 2 shows an arrangement mode of radial ribbed slabs 5 on a left box body 2 and analysis of force-bearing types and directions of bearing pedestals during gear meshing. On the left box body 2, the radial ribbed slabs 5 radially extend towards the periphery around a circle center, serving as a center, of a bearing pedestal until the radial ribbed slabs 5 are connected to the bolts 9.

The structure in which the radial ribbed slabs 5 are connected to the bolts 9 can further improve the support stiffness of the bolts 9, and restrain deformation of the box body caused by the impact of bolt screwing region. In addition, the casting manufacturability of a column, which has a suddenly changed thickness, in each bolt 9 can also be improved, and the radial ribbed slabs 5 are used as a flow guide channel to improve filling of the molten iron here, so that a casting defect caused by the sudden thickness change can be avoided, and the casting quality of a bolt connection surface can be improved.

The plurality of bolts 9 are arranged along the lateral box body 3 to form a curve similar to an outer contour of the lateral box body 3, and are non-uniformly arranged on the curve to connect the left box body 2, the lateral box body 3, and the right box body 4 together. Loosening and slipping of a mating face between the left box body 2 and the lateral box body 3 can be effectively restrained by optimizing the positions and layout of the bolts 9.

Specifically, as shown in FIG. 2, it is assumed that the small gear rotates at an angular velocity of ω1, and the large gear rotates at an angular velocity of ω2. By using the vertical direction as a reference and the circle center of the bearing pedestal as a center, the radial ribbed slabs 5 and the bolts 9 are arranged more densely in a sector region deviating from the vertical direction by a pressure angle α of ±30° than in another region.

In addition, the arrangement mode of the bolts may be not limited to the above structure, and the bolts may be uniformly arranged along the outer contour of the box bodies, or may be staggered, so as to closely connect the box bodies A cross section of the column of each bolt is not limited to a circle, and the column may be set as a non-uniform table or column with a non-equal cross section, or may be formed by irregular stacking of a local material for thickening, as long as the connection stiffness of each threaded hole can be ensured.

A thickened cylindrical body, a diameter of which is locally enlarged, may alternatively be arranged at a threaded blind hole. For example, the diameter of the cylindrical body is greater than a notional diameter of the threaded hole by 1 to 3 times, to ensure a processing allowance. The cylindrical body can enlarge a connection area between a threaded connection region and the cast box body and improve the connection stiffness of the threaded region, so as to restrain deformation and slippage of connection surfaces of the left box body, the right box body, and the lateral box body.

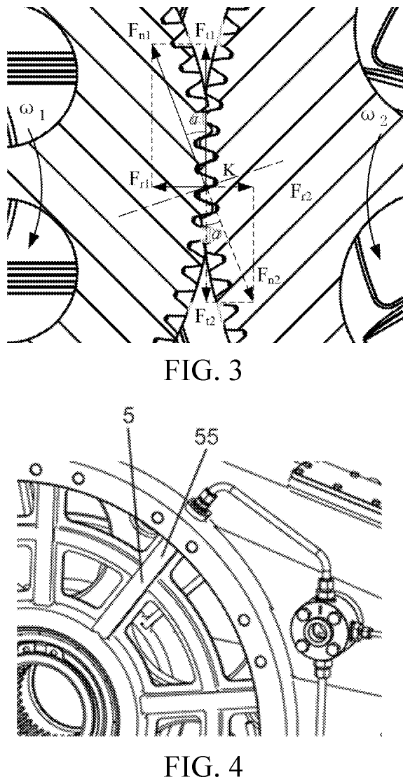

Formation of the pressure angle α will be described with reference to FIG. 2 and FIG. 3.

As shown in FIG. 3, when the small gear and the large gear in the parallel-level reduction gearbox are meshed, the small gear receives a positive pressure Fn1 at a meshing point. The positive pressure Fn1 may be equivalently decomposed into a radial force Fr1 toward the circle center and a tangent force Ft1 at the meshing point. An angle between the positive pressure Fn1 and the tangent force Ft1 is the pressure angle α.

In addition, the large gear receives a positive pressure Fn2 at a meshing point. The positive pressure Fn2 may be equivalently decomposed into a radial force Fr2 toward the circle center and a tangent force Ft2 at the meshing point. An angle between the positive pressure Fn2 and the tangent force Ft2 is the pressure angle α.

The forces that are received by the two gears at the meshing points are transmitted to the bearings of the gears and then to the bearing pedestals. In the following text, without particular distinction, the positive pressure is collectively referred to as a positive pressure Fn, the radial force is collectively referred to as a radial force Fr, and the tangent force is collectively referred to as a tangent force Ft.

FIG. 2 shows an equivalent diagram of the positive pressures Fn acting on the bearing pedestals, where the angle between each positive pressure Fn on the bearing pedestal and the tangent force Ft is the pressure angle α.

Since the region deviating from the vertical direction by the pressure angle α of ±30° is a key region under the impact of the force, in this region, the bolts 9 and the radial ribbed slabs 5 which are arranged densely can improve the support stiffness of the bearing pedestals to key force-bearing regions on the box bodies, thereby restraining a failure of connection of mating faces of the box bodies caused by the deformation of the box bodies.

Although in the structure shown in FIG. 2, the radial ribbed slabs 5 radially extending from the bearing pedestal of the small gear and the radial ribbed slabs 5 radially extending from the bearing pedestal of the large gear are both arranged densely in the region with the pressure angle α of ±30°, it is also possible that only the radial ribbed slabs 5 on the bearing pedestal of the small gear are arranged densely, or only the radial ribbed slabs 5 on the bearing pedestal of the large gear are arranged densely.

Therefore, the first bearing pedestal in the present disclosure may be referred to as the bearing pedestal of the small gear, or may be referred to as the bearing pedestal of the large gear. When the first bearing pedestal in the present disclosure is the bearing pedestal of the small gear, the second bearing pedestal is the bearing pedestal of the large gear. When the first bearing pedestal is the bearing pedestal of the large gear, the second bearing pedestal is the bearing pedestal of the small gear.

Preferably, an angle between the radial ribbed slabs 5 arranged in the key region deviating from the vertical direction by the pressure angle α of ±30° is 15° to 25°. This structure can effectively reduce displacement deformation of the bearing pedestal and the right box body in the plane under a positive pressure. In a region other than the key region, an angle between the radial ribbed slabs 5 may be set to 20° to 50°.

In addition, since the large gear at the output end of the reduction gearbox has a low speed, a larger torque needs to be output to drive a subsequent component to rotate (for example, a spline in a sun wheel or a spline in a crankshaft). In addition, the large gear at the output end and the box body at the output end are larger in size and lower in structural stiffness. As a result, the box body at this side is more likely to deform and vibrate. Therefore, the radial ribbed slabs 5 arranged on the box body at the output end of the reduction gearbox are strengthened and thickened to be 2 to 5 times of the width and thickness of the box body.

In addition, as shown in FIG. 4, a built-in oil path 55 for lubrication may further be embedded in the radial ribbed slab 5, and the built-in oil path 55 is integrally formed with the box body. In this case, the position of the radial ribbed slab 5 needs to be set with reference to a layout of an external lubrication oil path and a joint.

An angle between the radial ribbed slab 5 connected to a lubrication steel pipe led out from a lubrication oil separator and the vertical direction is between 0° and 30°, so as to facilitate the arrangement of the external lubrication oil path. Considering a diameter and length of an oil path, a unilateral margin between the built-in oil path 55 and the radial ribbed slab needs to be greater than 5 mm.

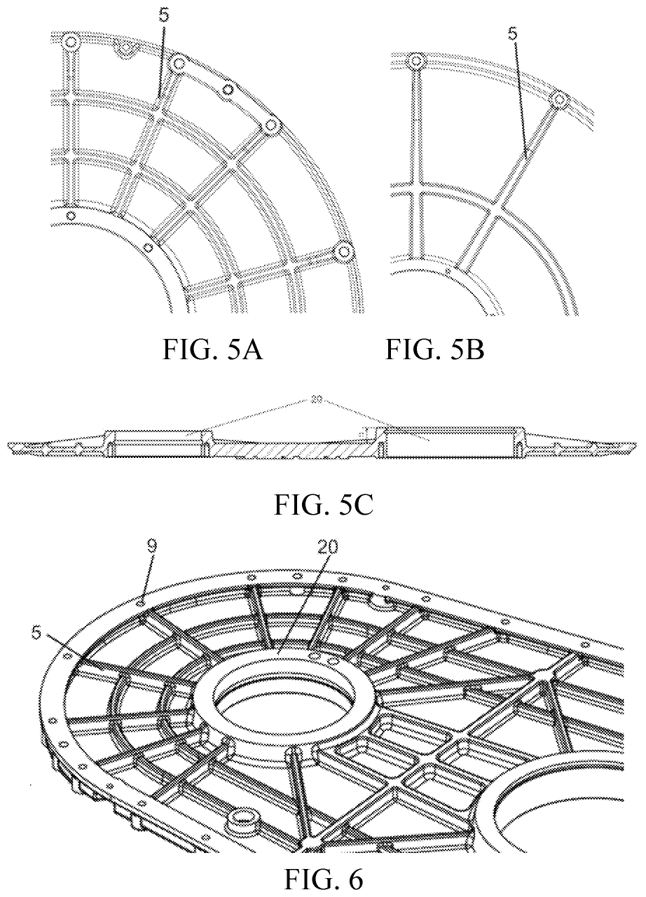

FIG. 5A and FIG. 5B show a shape of a radial ribbed slab 5 in a front view. As shown in FIG. 5A, two side surfaces, perpendicular to a surface of the left box body, of the radial ribbed slab 5 may be arranged in parallel.

Or, as shown in FIG. 5B, two side surfaces, perpendicular to the surface of the left box body, of the radial ribbed slab 5 are arranged in an angle. A width gradually decreases toward the lateral box body, and the angle between the two side surfaces is 5° or less. The radial ribbed slabs 5 having this angle can prevent the radial ribbed slabs themselves from pressing against each other in a large area under a load, to prevent a local stress concentration. This can further enhance the strength and stiffness of connection positions between the ribbed slabs and the bearing pedestals.

Since the radial ribbed slabs 5 shown in FIG. 1 are connected to both the bearing pedestal 20 and the bolts 9, heights of the ribbed slabs are affected by a distance from the bearing pedestal 20 to a surface of the box body and a distance from the bolts 9 to the surface of the box body.

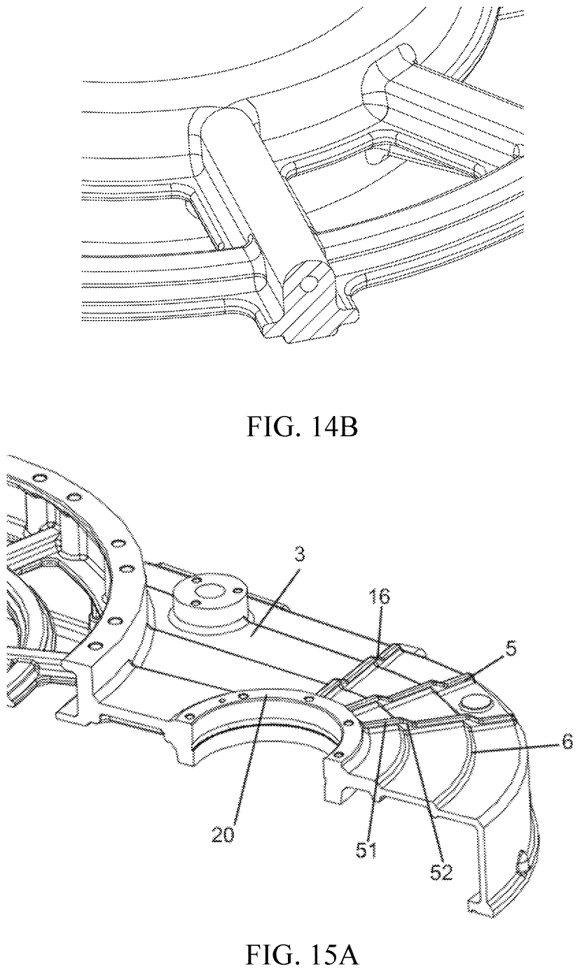

It can be seen from the cross-sectional view shown in FIG. 5C that a distance I1 is the distance from the bearing pedestal 20 to the surface of the box body. In addition, a distance I2 is marked in FIG. 14A below, and the distance I2 is a distance from the bolts 9 to the surface of the box body.

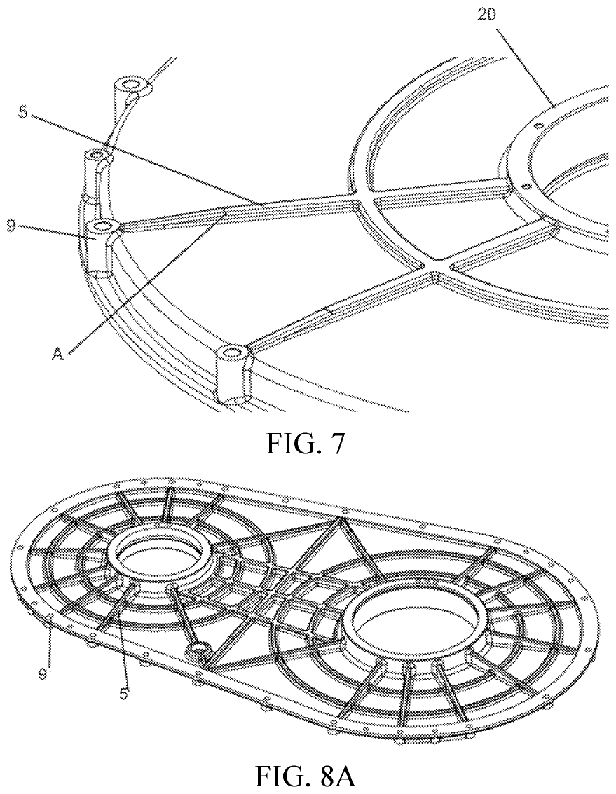

Specifically, a height of a start point (e.g., a connection point to the bearing pedestal) and a height of an end point (e.g., a connection point to the bolt 9) of the radial ribbed slab 5 are designed as follows:
(1) If I1−I2≤5 mm, as shown in FIG. 6, a top surface of the radial ribbed slab 5 is parallel to the surface of the left box body, and the height is a smaller value of I1 and I2.
(2) If 5 mm<I1−I2≤20 mm, as shown in FIG. 7, the top surface of the radial ribbed slab 5 close to the bearing pedestal 20 is parallel to the surface of the left box body, and the height is a larger value of I1 and I2. As the radial ribbed slab 5 gradually approaches the bolt 9, the top surface of the radial ribbed slab 5 is turned at point A. The top surfaces of the ribbed slab tilts toward the surface of the box body, and the height of the ribbed slab linearly gradually decreases until the ribbed slab is connected to the bolt 9.

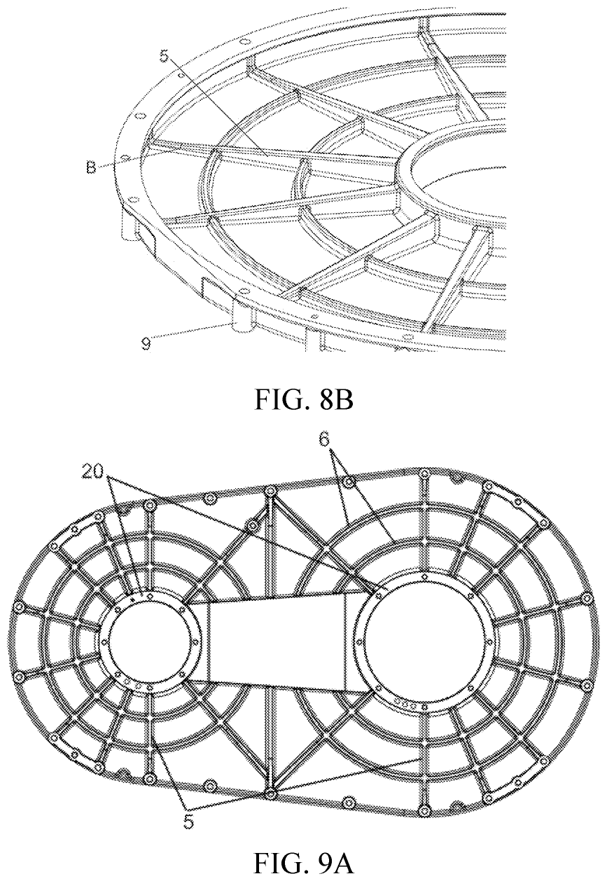

The turning point A is preferably located at a position that is away from the end point at a distance of ⅕ to ⅓ of a length of the radial ribbed slab 5, and an angle between the top surface of the tilting radial ribbed slab 5 and the surface of the box body is approximately in a range of 2° to 10°.
(3) If I1−I2≥20 mm, as shown in FIG. 8A, the top surface of the radial ribbed slab 5 tilts relative to the surface of the box body from the start point, so that the height of the top surface of the radial ribbed slab 5 linearly gradually decrease from the bearing pedestal toward the bolt 9 until the radial ribbed slab 5 is connected to the bolt 9.

In addition, when I1−I2≥20 mm, the radial ribbed slab 5 may further be set to be in a structure shown in FIG. 8B. In this structure, the top surface of the radial ribbed slab 5 starts to tilt relative to the surface of the box body from the start point. A difference from the structure shown in FIG. 8A is that the radial ribbed slab 5 is not directly obliquely connected to the bolt 9. Instead, after reaching a turning point B, the top surface of the radial ribbed slab 5 extends in a manner of being parallel to the surface of the box body until the radial ribbed slab 5 is connected to the bolt 9.

An angle between the top surface of the tilting radial ribbed slab 5 and the surface of the box body is approximately in a range of 2° to 15°.

Although it is not shown in the figure, the right box body is also provided with the radial ribbed slabs 5 arranged as above.

### 2.2 Peripheral Ribbed Slab

As shown in FIG. 1, the reduction gearbox 1 may be further provided with peripheral ribbed slab 6 intersecting with the radial ribbed slabs 5, for connecting the radial ribbed slabs 5 to each other, so that the radial ribbed slabs 5, the left box body 2, the lateral box body 3, the right box body 4, and the bolts 9 are connected to each other, thereby forming a reinforcing rib network having higher structural stiffness, and more effectively restraining bending, twisting, and deformation of a thin-walled box body.

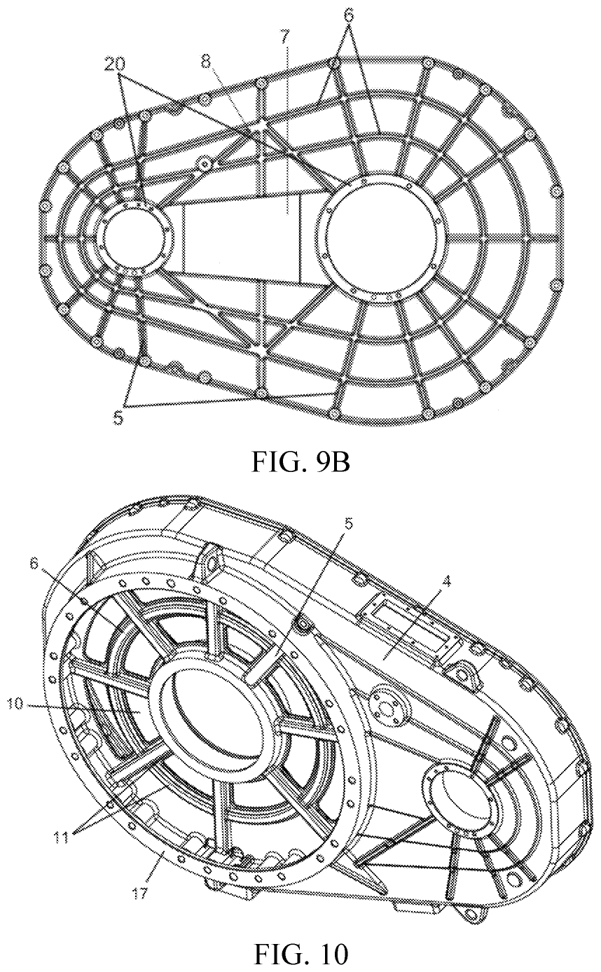

As shown in FIG. 9A, the peripheral ribbed slabs 6 may be set to be circular, using centers of the bearing pedestals 20 as circle centers, and vertically intersect with the radial ribbed slabs 5. Alternatively, as shown in FIG. 9B, the peripheral ribbed slabs 6 may be set to be in a shape formed by combining an arc segment and a straight line segment, to surround the circle centers of the two bearing pedestals 20 along the lateral box body 3.

However, the shapes of the peripheral ribbed slab 6 is not limited to this. Or, the peripheral ribbed slab may be a rectangle, a polygon, an irregular curve, a trapezoid, a circle, or the like, as long as peripheral ribbed slabs 6 can connect the radial ribbed slabs 5 to each other. In the present disclosure, one to five peripheral ribbed slabs may be properly arranged, but a quantity of the peripheral ribbed slabs may be selected according to an actual need.

In addition, a top surface of each peripheral ribbed slab 6 is parallel to a bottom surface of the peripheral ribbed slab 6, and a height from the peripheral ribbed slabs 6 and the surface of the box body is preferably 0.8 to 3 times of a wall thickness of the box body. If the height of each peripheral ribbed slab 6 is less than this range, the bending deformation of the box body cannot be effectively restrained, and the structural stiffness of the box body cannot be effectively improved. If the height of the peripheral ribbed slab 6 is greater than this range, the stiffness of the peripheral ribbed slab may be lowered. During operation of the reduction gearbox, the bending stress concentration at connection positions between the ribbed slab and the surface of the box body is exacerbated due to the deformation of the peripheral ribbed slab.

In addition, FIG. 10 shows another structure of radial ribbed slabs 5 and peripheral ribbed slabs 6 on a right box body 4. As shown in FIG. 10, the right box body 4 accommodates an output end of a large gear, and both the radial ribbed slabs 5 and the axial ribbed slabs 6 are thicker than conventional ribbed slabs.

In addition, weight-reducing openings 10 (the openings are first openings in the present disclosure) are provided in a partial region surrounded by the radial ribbed slabs 5 and the peripheral ribbed slabs 6, to reduce the weight of the box body. The lowest positions of the weight-reducing openings 10 are arranged above a liquid level of lubrication oil for a planet wheel, to ensure that a planetary shaft and its bearing can be lubricated.

Ribbed slab skirts 11 are arranged at portions of the radial ribbed slabs 5 along the weight-reducing openings 10 and portions of the peripheral ribbed slabs 6 along the weight-reducing openings 10, and a width of each ribbed slab skirt 11 is 1 to 5 times of a wall thickness of the box body. The arrangement of the ribbed slab skirts 11 can further enhance the structural stiffness of the ribbed slabs, which further strengthens connection points between the radial ribbed slabs 5 and the peripheral ribbed slabs 6, and restrains mutual displacement and deformation between the ribbed slabs that may be caused by weight-reducing openings 10.

In addition, as shown in FIG. 10, the right box body 4 is further formed with a flange boss 17 for being connected to another component. An axial angle is fixed by using two or more positioning pins, and axial alignment is achieved by using seam on an inner wall.

In the present disclosure, interfaces of flange boss of all parallel-level and planetary-level reduction gearboxes have consistent sizes. Therefore, without removing and replacing a planetary-level reduction gearbox, different transmission speed ratios of an entire pump can be quickly switched by replacing parallel-level reduction gearboxes with different speed ratios. It helps the platform of the entire pump to achieve a modularized and lightweight general-purpose design for a reduction gearbox.

### 2.3 Horizontal Ribbed Slab

As shown in FIG. 1, a horizontal ribbed slab 7 may be further arranged on the box body 1 of the reduction gearbox. The horizontal ribbed slab 7 is formed in a region between upper and lower tangent lines of the two bearing pedestals 20, and preferably, the horizontal ribbed slab 7 has a thickness of 1.5 to 3 times of a wall thickness of the box body.

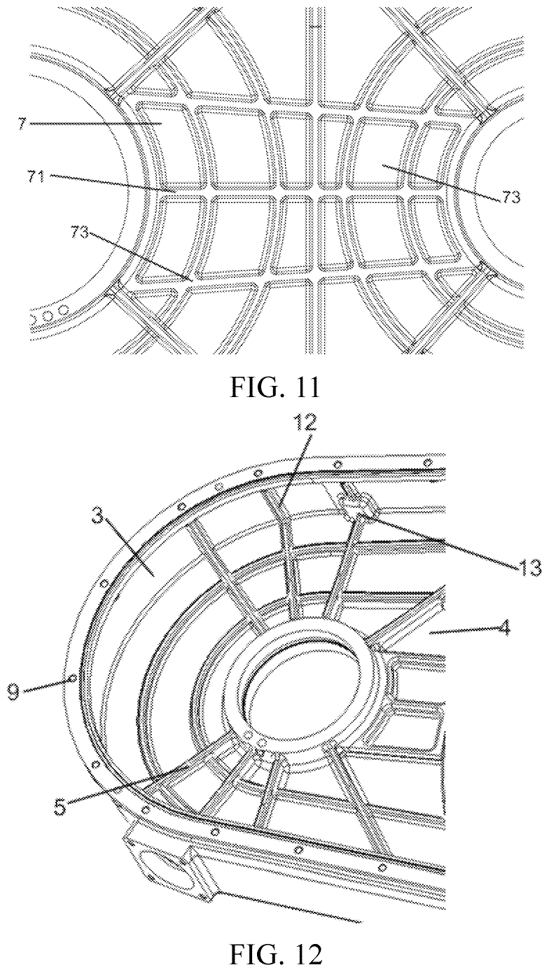

FIG. 11 shows a specific structure of a horizontal ribbed slab 7.

As shown in FIG. 11, the horizontal ribbed slab 7 includes a key ribbed slab 71 and an auxiliary ribbed slab 72 which are on a straight line connecting the circle centers of the bearing pedestals. The auxiliary ribbed slab 72 is symmetrically arranged by using the key ribbed slab 71 as a reference. In the present disclosure, an angle between the auxiliary radial ribbed slab 72 and the key radial ribbed slab 71 is 0° to 10° (including two end values). However, the present disclosure is not limited to this angle range, and the angle may be set according to a diameter ratio of the bearing pedestals under the condition of ensuring the structural stiffness and the attractive structural appearance.

A weight-reducing groove 73 is formed in a region surrounded by the key ribbed slab 71 and the auxiliary ribbed slab 72 (the opening is the weight-reducing groove in the present disclosure).

When two gears of a parallel-level reduction gearbox are driven, a horizontal component force caused by a reaction force is generated at a meshing point, so that the two gears have a trend to move away from each other. Therefore, adding the horizontal ribbed slab 7 between the two bearing pedestals can effectively resist the opposite horizontal component force, and prevent a transmission error caused by a change in a center distance between the gears.

### 2.4 Vertical Ribbed Slab

As shown in FIG. 1, vertical ribbed slabs 8 may be further arranged on the box body 1 of the reduction gearbox. The vertical ribbed slabs 8 are perpendicular to a connection line between the circle centers of the two bearing pedestals 20, and are connected to the bolts 9.

Referring to FIG. 9B again, it can be seen that the radial ribbed slabs 5 that are led out from the circle centers of the bearing pedestals 20 can be connected to the vertical ribbed slabs 8, thus forming stable triangular structures by the radial ribbed slabs 5, the vertical ribbed slabs 8, and the horizontal ribbed slab 7, to further restrain an inverted displacement between gears and ensure stable and accurate transmission.

In the present disclosure, a quantity of the vertical ribbed slabs 8 may be selected according to the center distance between the bearing pedestals, so as to improve the stiffness of connection and supporting between the bearing pedestals.

### 2.5 Axial Ribbed Slab

In addition, as shown in FIG. 12, axial ribbed slabs 12 and turning ribbed slabs 13 may be further arranged inside the lateral box body 3.

The axial ribbed slabs 12 are perpendicular to the left box body (not shown) and the right box body 4. One end of each axial ribbed slab 12 is connected to each bolt 9, and the other end is connected to each radial ribbed slab 5 through each turning ribbed slab 13. As shown in FIG. 12, the turning ribbed slab 13 is located at a connection position between the lateral box body 3 and the right box body 4.

However, the present disclosure is not limited to this. Two ends of the axial ribbed slabs 12 may be connected to the radial ribbed slabs 5 through the turning ribbed slabs 13.

By using this structure, the support stiffness of the bolts 9 on the box body can be improved, and bending, twisting, deformation, and the like of a thin-walled box body can be restrained.

### 2.6 Sealing Structure

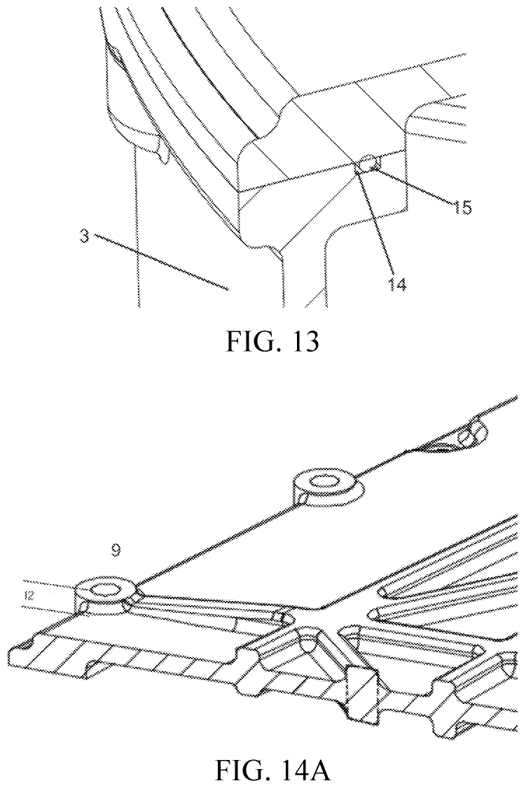

FIG. 13 shows a sealing structure in a mating face of a box body. As shown in FIG. 13, a sealing structure is included in a mating face between a left box body or a right box body and a lateral box body 3.

The sealing structure shown in FIG. 13 includes a sealing slot 14 and a sealing member 15. The sealing slot 14 is arranged along a circle of the lateral box body 3 and has a rectangular cross section, and includes the sealing member 15 inside. The sealing member 15 includes, but is not limited to, a sealing gasket, a sealing tape, a sealing ring, and the like.

Although FIG. 13 only shows that the mating face between the lateral box body 3 and an end surface of one side includes a sealing structure, a sealing structure may be arranged in the mating faces between the lateral box body 3 and end surfaces of two sides, or the sealing structure may not include the sealing slot, and instead, sealing is directly performed using a sealant.

Through external bolting, the sealing member is compressed on the mating face, and a gap on the mating face is filled by elastic deformation generated due to compression, to generate a contact pressure, thereby preventing leakage of internal oil and invasion of external dirt and moisture and preventing negative consequences, such as lubricating oil pollution and gear meshing point wear, caused by moisture.

### 2.7 Shape of Ribbed Slab

FIG. 14A and FIG. 14B show different cross-sectional shapes of a ribbed slab. As shown in FIG. 14A, all the ribbed slabs may have rectangular cross sections. Compared with a solid regular cross-sectional shape (such as a circle or a square) having the same area, this rectangular cross section can ensure a ribbed slab have enough bending stiffness because its long axis has a larger inertia moment, thus restraining displacement and deformation of a thin-walled box body.

In addition, as shown in FIG. 14B, in a case that there is a requirement for a built-in oil path, the cross section of the ribbed slab may be further set to a semicircular cross section, and a hole is provided in the ribbed slab to arrange an oil path, so as to satisfy a processing margin and reduce the weight.

In addition, the cross section of the ribbed slab may be further set to be a trapezoidal cross section having oblique angles on two sides, to enhance the strength of a root portion of the ribbed slab, or may be set to be in any shape satisfying a support requirement and a casting process according to a need.

In the present disclosure, an improvement idea for the box body of the parallel-level reduction gearbox is approximately the same as that for the box body of the parallel-level+planetary-level reduction gearbox. Therefore, the foregoing arrangement structures described for the box body of the parallel-level+planetary-level reduction gearbox is also applicable to the box body of the parallel-level reduction gearbox, so as to, in a case that the center distance between the bearing pedestals is effectively maintained, improve the connection stiffness of the box body, restrain bending and twisting deformation of the box body, and ensure accurate transmission of the internal gears.

In addition, the various ribbed slabs such as the radial ribbed slabs, the peripheral ribbed slabs, the horizontal ribbed slabs, and the vertical ribbed slabs and related structures may be freely selected and combined as required. Namely, some or all of the ribbed slabs and related structures may be used in box body of the reduction gearbox.

In addition, although only the left box body is used for description in the accompanying drawings, a person skilled in the art may understand that the above structures such as the various ribbed slabs may be adaptively arranged in the right box body. Descriptions for the right box body are the same.

### 3. Step-like Arrangement of a Box Body of a Reduction Gearbox

To improve the capability of the box body of the reduction gearbox to resist bending deformation, the box body of the reduction gearbox may be further designed to be in a step-like foldable arrangement having a plurality of step planes, so as to transform a planar structure of the box body into a three-dimensional structure.

### 3.1 Step-like Arrangement of a Parallel-Level+ Planetary-Level Reduction Gearbox

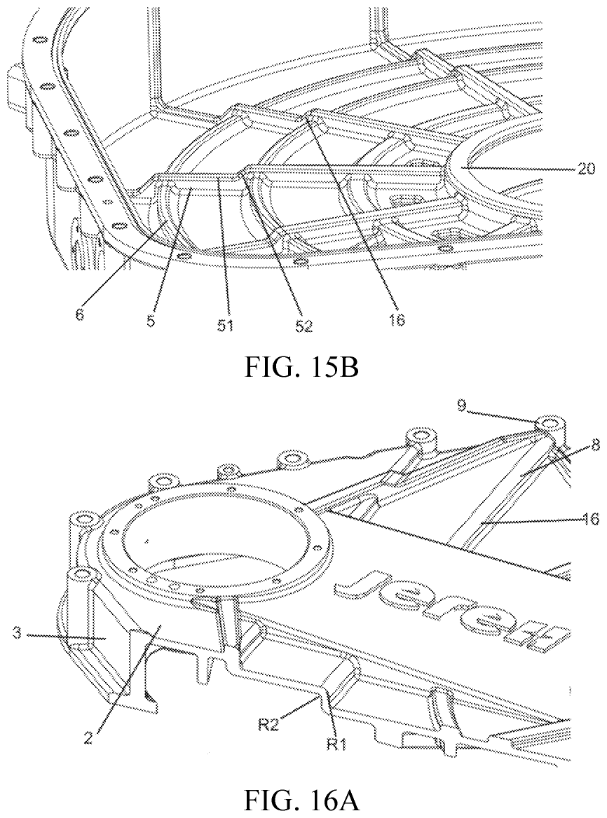

FIG. 15A and FIG. 15B show a step-like structure of a parallel-level box body of a parallel-level+ planetary-level reduction gearbox.

FIG. 15A is an outer side view of the step-like structure. As shown in FIG. 15A, in a direction from a circle center of a bearing pedestal to a lateral box body 3, an input side box body for accommodating a small gear is formed into a step-like structure having a plurality of step portions 16. In FIG. 15A, a height of the step-like structure gradually decreases in a direction from a bearing pedestal 20 of the small gear to the lateral box body 3.

Peripheral ribbed slabs 6 are at least partially formed on the step portions 16. For the arrangement of the peripheral ribbed slabs 6, refer to the foregoing descriptions, and details will not be described here.

Namely, a quantity of the step portions 16 of the step-like structure on the box body and spacings between the step portions are related to a quantity of turns of the peripheral ribbed slabs 6 and spacings between the peripheral ribbed slabs 6, and the quantity n of the step portions 16 is the same as the quantity of turns of the peripheral ribbed slabs 6. In the present disclosure, the quantity n of the step portions 16 is preferably set to 2, but it is not limited thereto, or n may be set to any integer ≥2 according to a need.

The spacings between the plurality of step portions 16 may be set to be equal to each other, or the spacing may be set to be different from each other. For example, the spacings gradually increase or decrease in the direction from the circle center of the bearing pedestal to the lateral box body 3.

To ensure a uniform thickness at a corner of each step portion 16, an outer round radius R1 of an outer side of the box body at the corner is twice an inner round radius R2 of an inner side of the box body.

In addition, a height of each step portion 16 may be set to be the same as each other or different from each other. When a sum of the heights of the step portions 16 is fixed, the height of each step portion 16 is in inversely proportion to the quantity of the step portions 16. In the present disclosure, the height of each step portion 16 is preferably set to 0.5 to 2 times of a wall thickness of the box body.

In a case that the box body is formed into the step-like structure, each radial ribbed slab 5 is formed into a step-like structure, and a top surface of the radial ribbed slab 5 is alternately formed by a horizontal plane 51 and an inclined plane 52. The horizontal plane 51 is parallel to an extension surface of the left box body; and the inclined plane 52 is formed on a plane where each step portion 16 intersects with the extension surface. An angle between the inclined plane 52 and the horizontal plane 51 is preferably less than 45°, but the angle is not limited to this, as long as gentle transition at the corner can be ensured.

The structure of the radial ribbed slab 5 can better ensure a uniform wall thickness change between the box body and the radial ribbed slab 5, thereby avoiding a casting defect caused by a sudden change in the thickness of the radial ribbed slab 5 on a stepped surface.

FIG. 15B is an inner side view of the step-like structure. As shown in FIG. 15B, a step-like structure, a peripheral ribbed slab 6, and a radial ribbed slab 5 are further formed on an inner side of the input side box body for accommodating the small gear.

Corresponding to FIG. 15A, a height of the step-like structure gradually decreases in the direction from the bearing pedestal 20 of the small gear to the lateral box body 3. The peripheral ribbed slab 6 is formed at the step portion 16, and the radial ribbed slab 5 is also formed into a step-like structure. Furthermore, a top surface of the radial ribbed slab 5 is alternately formed by a horizontal plane 51 and an inclined plane 52. The inclined plane 52 is formed on the above step portion 16.

By forming the box body into the above step-like structure, the planar box body can be transformed into a three-dimensional structure, and the step portions and the step-like radial ribbed slabs can enable a plurality of planes to support each other, thereby significantly improving the structural stiffness of the box body.

In addition, although FIG. 15A to FIG. 15B show that the step-like structure is formed in a portion around the bearing pedestal of the small gear, the step-like structure may be further formed in a portion around the bearing pedestal of the large gear.

Therefore, similar to the previous description, the first bearing pedestal in the present disclosure may be referred to as the bearing pedestal of the small gear, or may be referred to as the bearing pedestal of the large gear. When the first bearing pedestal in the present disclosure is the bearing pedestal of the small gear, the second bearing pedestal is the bearing pedestal of the large gear. When the first bearing pedestal is the bearing pedestal of the large gear, the second bearing pedestal is the bearing pedestal of the small gear.

### 3.2 Stepped Deployment of Single-Parallel-Level Reduction Gearboxes

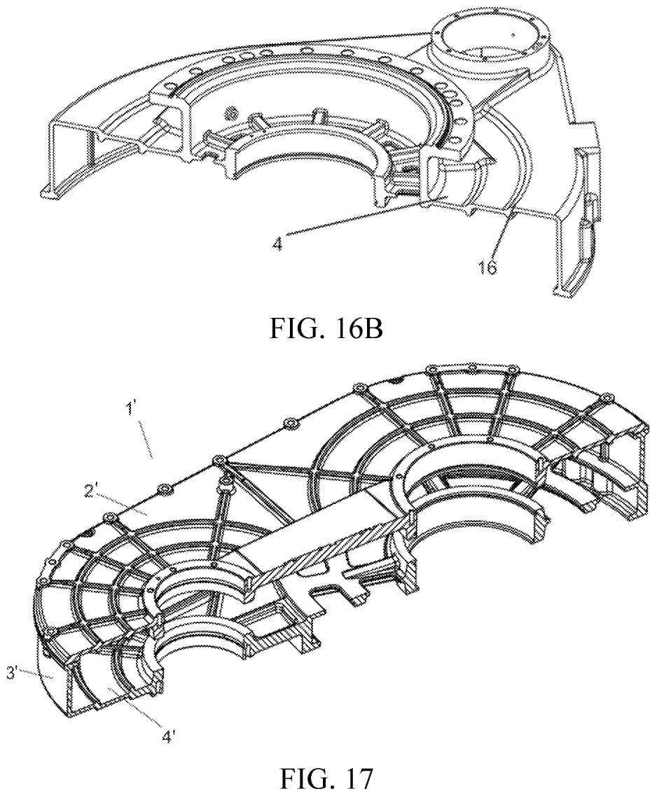

FIG. 16A and FIG. 16B show a step-like structure of a box body of a single-parallel-level reduction gearbox.

Although in the present disclosure, an improvement idea for the box body of the parallel-level reduction gearbox is approximately the same as that for the box body of the parallel-level+planetary-level reduction gearbox, in the parallel-level reduction gearbox, since the small gear is thicker than the large gear and a difference between the thicknesses of the two gears is significant, a pair of bearing pedestals that support the small gear are far away from each other in an axial direction and a pair of bearing pedestals that support the large gear are close to each other in the axial direction, causing a large difference in relative positions of the bearing pedestals of the two gears on the axis. Therefore, the overall stiffness of the bearing pedestals may be insufficient, and the box body may vibrate and deform when the small gear and the large gear are meshed at a high frequency.

Based on this, a weak portion of the parallel-level reduction gearbox needs to be further strengthened.

Therefore, in addition to the above arrangement structures described for the box body of the parallel-level+planetary-level reduction gearbox, in the present disclosure, the box body on the small gear side (input side) of the left box body 2 and the box body on the large gear side (output side) of the right box body 4 of the parallel-level reduction gearbox are further formed into step-like structures having a plurality of step portions 16.

FIG. 16A shows a step-like structure on a small gear side in a left box body 2 of a parallel-level reduction gearbox. As shown in FIG. 16A, on the small gear side in the left box body 2, the step-like structure is configured to have a plurality of step portions 16, and vertical ribbed slabs 8 are at least partially formed at the step portions 16. A height of the step-like structure gradually decreases in a direction from a small gear to a large gear.

Since a distance between a bearing pedestal of the small gear side and a lateral box body 3 is short, no peripheral ribbed slab 6 is formed on the small gear side.

Although the structure of only a portion of the left box body 2 is shown in FIG. 16A, in the present disclosure, the vertical ribbed slabs 8 are connected to two bolts 9 in a vertical direction.

To ensure a uniform thickness at a corner of each step portion 16, an outer round radius R1 of an outer side of the box body at the corner is twice an inner round radius R2 of an inner side of the box body.

FIG. 16B shows a step-like structure on a large gear side in a right box body 4 of a parallel-level reduction gearbox. As shown in FIG. 16B, on the large gear side in the right box body 4, the step-like structure is formed into a structure having a plurality of step portions 16. A height of the step-like structure gradually decreases in a direction from a large gear to a small gear. However, a difference from the structure shown in FIG. 16A is that peripheral ribbed slabs 6 are formed at the step portions 16.

In addition, in FIG. 16A and FIG. 16B, radial ribbed slabs 5 may be further formed. A structure and forming mode of the radial ribbed slabs 5 are the same as those in FIG. 15A and FIG. 15B, and details will not be described here again. However, since the bearing pedestals of the parallel-level reduction gearbox are far away from the bolts, as the radial ribbed slabs extend to the lateral box body, a radial force thereon gradually decreases. Therefore, to reduce the weight to the greatest extent, referring to FIG. 7 here again, the width of each radial ribbed slab 5 in a radial direction gradually decreases.

In addition, within a range deviating from the vertical direction by the pressure angle α of ±30°, the width of each radial ribbed slab 5 is set to 1.1 to 2 times of the width of each radial ribbed slab 5 in another range. In addition, the box body is thickened in a range between two tangent lines of the two bearing pedestals 20 relative to another range, and the horizontal ribbed slab 7 between the two bearing pedestals 20 is thickened too.

In this way, the structure in which both the box body between the bearing pedestals and the horizontal ribbed slab are thickened can effectively resist an inverted displacement between the two gears, and prevent a transmission error caused by a change in the center distance between the gears.

By forming the box body into the above step-like structure, the planar box body can be transformed into a three-dimensional structure, which effectively shortens the distances between the bearing pedestals and a surface of the box body. Furthermore, the step portions and the step-like radial ribbed slabs can enable a plurality of planes to support each other, thereby significantly improving the structural stiffness of the box body.

Although FIG. 16A to FIG. 16B respectively show different step-like structures on the small gear bearing pedestal side and the large gear bearing pedestal side, in the present disclosure, the step-like structure shown in FIG. 16A may alternatively be formed on the large gear bearing pedestal side, and the step-like structure shown in FIG. 16B may alternatively be formed on the small gear bearing pedestal side.

In addition, the step-like structure shown in FIG. 16A may be formed only on the small gear bearing pedestal side or the large gear bearing pedestal side, or the step-like structure shown in FIG. 16B may be formed only on the small bearing pedestal gear side or the large gear bearing pedestal side.

Therefore, as mentioned above, the first bearing pedestal in the present disclosure may be referred to as the bearing pedestal of the small gear, or may be referred to as the bearing pedestal of the large gear. When the first bearing pedestal in the present disclosure is the bearing pedestal of the small gear, the second bearing pedestal is the bearing pedestal of the large gear. When the first bearing pedestal is the bearing pedestal of the large gear, the second bearing pedestal is the bearing pedestal of the small gear.

In addition, as shown in FIG. 16A, a column of the bolt 9 rises up due to the step-like structure, so that a top bolt positioning surface rises above a wall surface of the box body. This may cause the columns of the bolts 9 on the entire left box body 2 to have different heights. To unify the model numbers of connection bolts, reduce the management costs of parts, and increase the assembling speed, the heights of the columns of the bolts of the right box body 4 are correspondingly adjusted, so that the columns of the bolts have consistent heights after the left box body 2 and the right box body 4 are combined.

Although not shown in the figure, the structural features in FIG. 1 to FIG. 14B can be adaptively applied to the step-like structures shown in FIG. 16A to FIG. 16B.

### II. Second Embodiment of a Box Body of a Reduction Gearbox According to the Present Disclosure

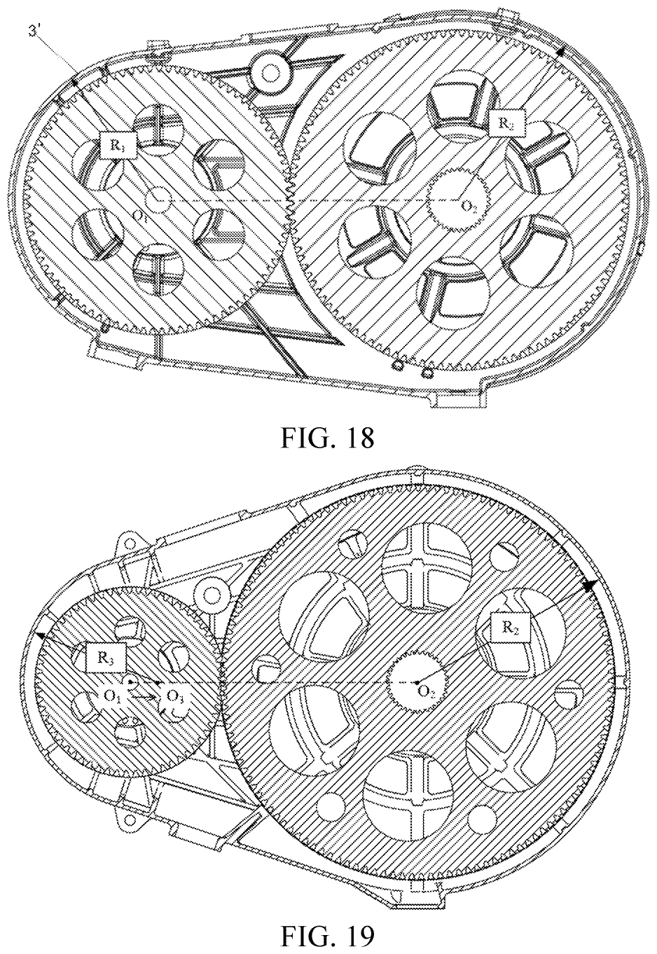

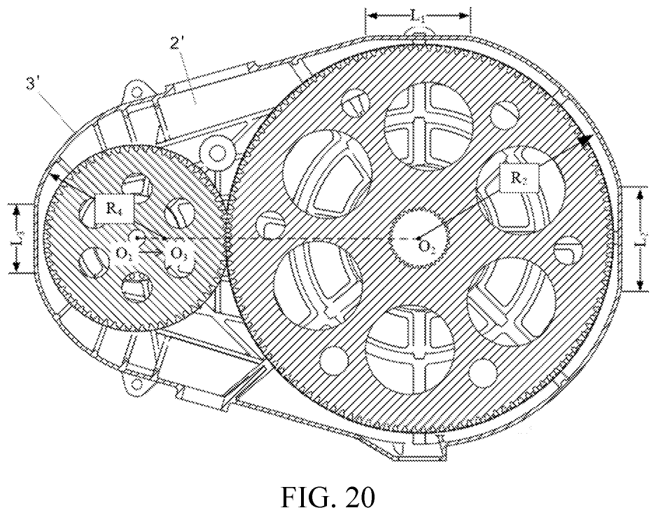

FIG. 17 is a three-dimensional diagram sectioned along a box body of a reduction gearbox according to another aspect of the present disclosure. FIG. 18 exemplarily shows a front view of a first contour structure of a box body in the present disclosure. FIG. 19 exemplarily shows a front view of a second contour structure of a box body in the present disclosure. FIG. 20 exemplarily shows a front view of a third contour structure of a box body in the present disclosure.

As shown in FIG. 17, the box body 1′ of the reduction gearbox includes a left box body 2′ located at an input end of the reduction gearbox, a lateral box body 3′, and a right box body 4′ located at an output end of the reduction gearbox. In the present disclosure, the left box body 2′ and the right box body 4′ are connected to the lateral box body 3′ through bolts arranged along an outer edge of the box body.

Although, shown in the figure, the left box body and the right box body are connected to the lateral box body are connected through the bolts, the left box body and the right box body may alternatively be connected to the lateral box body in another way, such as welding.

In the present disclosure, the box body of the reduction gearbox at least accommodates parallel-level gears, and the parallel-level gears include a small gear at the input end and a large gear meshed with the small gear. A bearing pedestal for supporting a bearing of the small gear and a bearing pedestal for supporting a bearing of the large gear are further arranged on the box body of the reduction gearbox.

In FIG. 18 to FIG. 20, the small gear on the left side is an input end gear, and a circle center of the small gear and a circle center of the bearing pedestal, corresponding to the small gear, on the left box body 2′ are O1; a radius of the small gear is R1; the large gear on the right side is an output end gear; a circle center of the large gear and a circle center of the bearing pedestal, corresponding to the large gear, on the left box body 2′ are O2; and a radius of the large gear is R2.

As shown in FIG. 18, since the lateral box body 3′ needs to surround the input end gear and the output end gear, according to an outer contour of the lateral box body 3′, a portion close to the input end gear and a portion close to the output end gear are formed into circular-arc portions. A circle center of the circular-arc portion close to the bearing pedestal of the small gear and the circle center of the bearing pedestal of the small gear overlap, both of which are O1. In addition, a circle center of the circular-arc portion close to the bearing pedestal of the large gear and the circle center of the bearing pedestal of the large gear overlap, both of which are O2.

In addition, the lateral box body 3′ further includes two straight line portions, and the two straight line portions are respectively tangent to the circular-arc portion close to the bearing pedestal of the small gear and the circular-arc portion close to the bearing pedestal of the large gear. Namely, the lateral box body 3′ is formed by the circular-arc portion close to the bearing pedestal of the small gear, the circular-arc portion close to the bearing pedestal of the large gear, and the two straight line portions tangent to the two circular-arc portions.

In the structure shown in FIG. 18, the circle center of the circular-arc portion close to the bearing pedestal of the small gear overlaps the circle center of the bearing pedestal of the small gear. Namely, in the present disclosure, the first bearing pedestal is the bearing pedestal of the small gear, and the first circular-arc portion is the circular-arc portion close to the bearing pedestal of the small gear. Meanwhile, the second bearing pedestal is the bearing pedestal of the large gear, and the second circular-arc portion is the circular-arc portion close to the bearing pedestal of the large gear.

However, the present disclosure is not limited to this. The first bearing pedestal may alternatively be the bearing pedestal of the large gear. In this case, the second bearing pedestal is the bearing pedestal of the small gear. In this case, the first circular-arc portion is correspondingly the circular-arc portion close to the bearing pedestal of the large gear, and the second circular-arc portion is correspondingly the circular-arc portion close to the bearing pedestal of the small gear.

The explanations of the first bearing pedestal, the second bearing pedestal, the first circular-arc portion, and the second circular-arc portion are also applicable to the following structures. Therefore, details will not be described here again.

In addition, the structure of the box body of the present disclosure is not limited to the structure shown in FIG. 18, and the circle centers of the circular-arc portions of the lateral box body 3′ may not overlap the circle centers of the bearing pedestals.

As shown in FIG. 19, a circle center of the circular-arc portion close to the bearing pedestal of the small gear is O3, and a radius is R3. It can be seen from FIG. 19 that the radius R3 of the circular-arc portion is greater than the radius R1 of the small gears. Therefore, the circle center O3 of the circular-arc portion is located on a connection line between the circle center O1 of the bearing pedestal of the small gear and the circle center O2 of the bearing pedestal of the large gear.

In the present disclosure, there is R1<R3<R2. Preferably, the radius R3 is set to 1.2 to 1.8 times of the radius R1. More preferably, a distance between the circle center O3 of the circular-arc portion with the radius R3 and the circle center O1 of the bearing pedestal of the small gear is between 50 mm and 150 mm.

By using the structure shown in FIG. 19, a significant difference between a size of a small gear accommodating portion and a size of a large gear accommodating portion can be reduced from the appearance of the box body.

In addition, FIG. 20 shows a further improvement based on the structure of FIG. 19. As shown in FIG. 20, at a portion where the connection line (horizontal direction) between the circle center O1 and the circle center O2 intersects the box body of the reduction gearbox, the lateral box body 3′ is formed with a straight line segment L2 and a straight line segment L3. Meanwhile, the left box body 2′ and the right box body (not shown) are formed into shapes having straight line segments at corresponding portions.

Preferably, in the vertical direction perpendicular to the connection line, at a portion where a vertical line passing through the circle center O2 intersects the box body of the reduction gearbox, the lateral box body 3′ is further formed with a straight line segment L1 too. Namely, it can be seen from FIG. 20, the straight line segment L1 overlaps the circle center O2 in the vertical direction. Meanwhile, the left box body 2′ and the right box body 4′ are formed into shapes having straight line segments at corresponding portions.

Lengths of the straight line segments L1, L2, and L3 are not limited, as long as the lengths can ensure that a distance between the lateral box body 3′ and tops of the gears is greater than 10 mm.

By using the structure, the size of the entire reduction gearbox can be reduced, and the weight of the box body of the reduction gearbox can be reduced. Furthermore, the feeling that the reduction gearbox looks bulky is reduced through the contour structures having the straight line segments.

In addition, although FIG. 20 shows an improved solution based on the structure of FIG. 19, the box body shown in FIG. 20 and including the straight line segments L1 to L3 may use the structure, shown in FIG. 18, in which the circle centers of the circular-arc portions of the lateral box body overlap the circle centers of the gears.

In conclusion, according to the box body of the reduction gearbox, by changing the appearance of the box body of the reduction gearbox, the size of the reduction gearbox can be reduced; the weight of the box body can be reduced; the costs can be reduced; and the appearance of the reduction gearbox can be more beautiful.

### III. Embodiment of a Reduction Gearbox According to the Present Disclosure

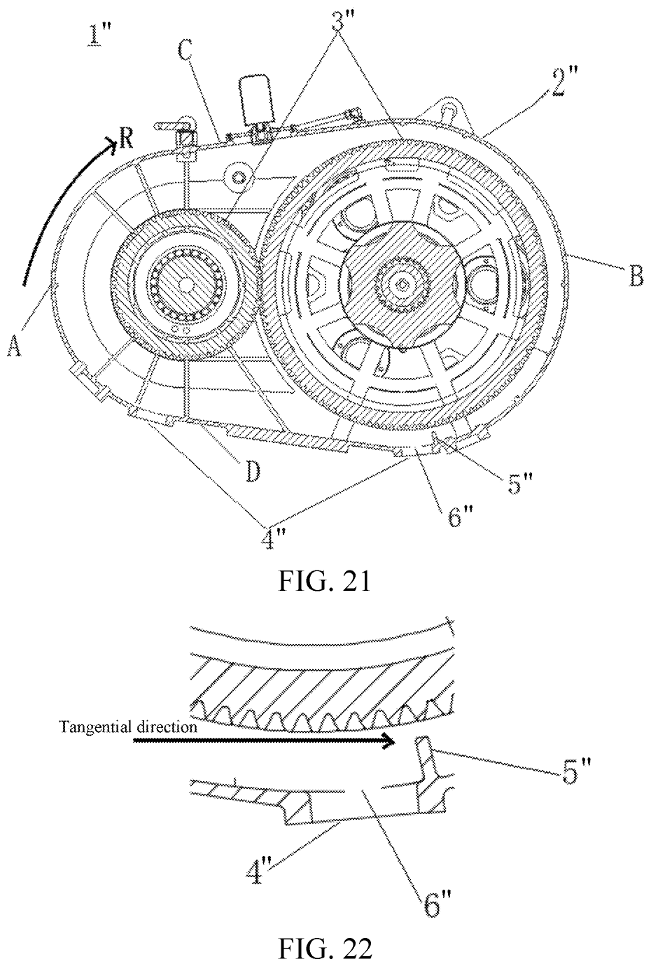

FIG. 21 is a schematic diagram of a reduction gearbox 1″ according to an example of the present disclosure, and FIG. 22 is an enlarged view of an oil return port in FIG. 21. As shown in FIG. 21, the reduction gearbox 1″ includes a box body 2″ and a gear apparatus 3″. In the example shown in FIG. 21, the box body 2″ includes, in a circumferential direction R, a left circular-arc portion A, a right circular-arc portion B, an upper flat portion C, and a lower flat portion D which are used as a wall of the box body 2″. The upper flat portion C is in tangent connection to both an upper side of the left circular-arc portion A and an upper side of the right circular-arc portion B, and the lower flat portion D is in a tangent connection to both a lower side of the left circular-arc portion A and a lower side of the right circular-arc portion B. The upper flat portion C and the lower flat portion D are described relative to the left circular-arc portion A and the right circular-arc portion B, which means that the upper flat portion C and the lower flat portion D are roughly linear in a cross-sectional view shown in FIG. 21, rather than curves like the left circular-arc portion A and the right circular-arc portion B. It should be noted that, the upper flat portion C and the lower flat portion D described here do not limit surfaces of the portions to be absolute planes, but the surfaces may have protrusion for connection and the like. The gear apparatus 3″ is arranged inside the box body 2″ and usually includes, for example, a group of two gears. When the reduction gearbox operates, the two gears are meshed with each other to rotate, thus transmitting power. Although not shown in detail, the reduction gearbox 1″ further includes a lubrication system. The lubrication system provides lubricating oil for lubrication for the operation of the reduction gearbox 1″. For example, the lubricating oil is provided for the rotating gear apparatus 3″ to reduce dry friction and bring away heat. An appropriate amount of the lubricating oil provided to the inside of the box body 2″ can ensure normal and efficient operation of the reduction gearbox. When the amount of the lubricating oil inside the reduction gearbox 1″ is excessively small, sufficient lubrication and heat dissipation effects may not be achieved. When the amount of the lubricating oil inside the reduction gearbox 1″ is excessively large, the resistance to the viscosity of the lubricating oil on the gears may increase, and a power loss caused by a pumping action of gear meshing on the lubricating oil also increases. Thus, the operation effect of the reduction gearbox 1″ may be affected. In this case, the redundant lubricating oil needs to be discharged from the box body 2″. Therefore, the reduction gearbox 1″ is further provided with an oil return port 4″, and the redundant lubricating oil may be discharged from the box body 2″ through the oil return port 4″. As shown in FIG. 21, the oil return port 4″ is arranged on the wall of the box body 2″ of the reduction gearbox 1″. Although two oil return ports 4″ are shown in FIG. 21, this is only an example, and a quantity of the oil return ports 4″ is not limited to two. There may be one or more oil return ports.

To ensure that the lubricating oil flows out smoothly, for the reduction gearbox 1″ having different requirements for a mounting angle, the quantity and arrangement angle of the oil return port 4″ are not limited. After the reduction gearbox is mounted, at least one oil return port 4″ exists at a low point. Namely, in a mounted state of the reduction gearbox 1″, at least one oil return port 4″ is arranged on a wall of a bottom of the box body 2″. An auxiliary oil return port (not shown in the figure) may be randomly arranged at another position of the box body 2″, including but not limited to a bottom of a lateral peripheral surface of the box body 2″ (here, the lateral peripheral surface is a surface, partially surrounding the gear apparatus 3″, of a side surface of the box body 2″, for example, in the view of FIG. 21, surfaces, partially surrounding the gear apparatus 3″, on left and right sides of the box body 2″), such as bottoms of the left circular-arc portion A and the right circular-arc portion B shown in FIG. 21. Or, the auxiliary oil return port may be provided in any angle in a rear end surface of the box body 2″ (the rear end surface of the box body 2″ is an end surface connected to a power device), as long as it can ensure smooth oil return and satisfaction of an arrangement space of an oil return pipe of the entire machine.

In addition, as shown in FIG. 21 and FIG. 22, an oil baffle plate 5″ is arranged close to the oil return port 4″, on a path in which the lubricating oil splashes out in a tangential direction (shown by the arrow in FIG. 22) of the gears, and can block the lubricating oil, so that the lubricating oil flows out from an oil return through hole 6″ along the oil baffle plate 5″. The oil baffle plate 5″ is as high as possible without interfering with the gears of the gear apparatus 3″. A higher oil baffle plate 5″ can block lubricating oil that has an excessively high speed in the tangential direction, thus achieving a better blocking effect. Since the oil baffle plate is manufactured by a casting process and is uniformly cast, a thickness of the oil baffle plate 5″ is not limited (for example, the thickness of the oil baffle plate 5″ is usually ≥5 mm), and a cross section of the oil baffle plate 5″ is not limited to a regular rectangle, or the cross section may be a trapezoidal cross section with a strengthened root portion, or another cross section that can achieve an oil blocking effect. The oil baffle plate 5″ here may be integrally formed with the box body 2″, for example, by casting. In some implementations, the oil baffle plate 5″ may alternatively be formed with a protrusion structure having an oil blocking function only by local stacking for thickening.

To implement a lightweight design of the reduction gearbox 1″, the parallel-level box body is designed to be extremely compact, and a distance between an inner wall and an internal rotating gear is short. To avoid a phenomenon of gear churning caused by the fact that there is no enough space for the lubricating oil that splashes out in the tangential direction of gear teeth to fall into the oil return port at the bottom, the oil return port 4″ of the present disclosure may be sunken, so as to extend the distance between the oil return port 4″ and addendum circles of the gears, to facilitate settlement and discharging of the lubricating oil. A specific sinking height of the oil return port 4″ is not limited, as long as it can ensure smooth oil return and satisfaction of an arrangement space of an oil return pipe of the entire machine. In addition, no limitation will be imposed on the mode for sinking the oil return port 4″. The oil return port 4″ may be sunken entirely from its bottom surface, or may be sunken partially from its periphery.

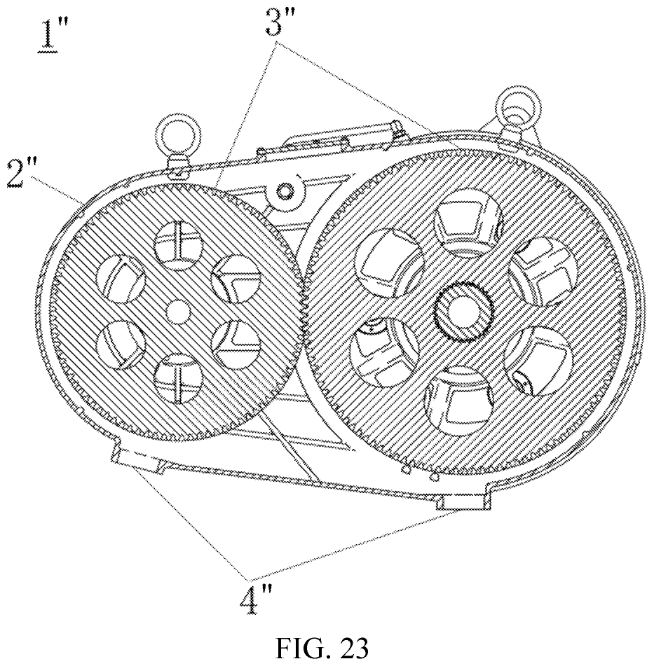

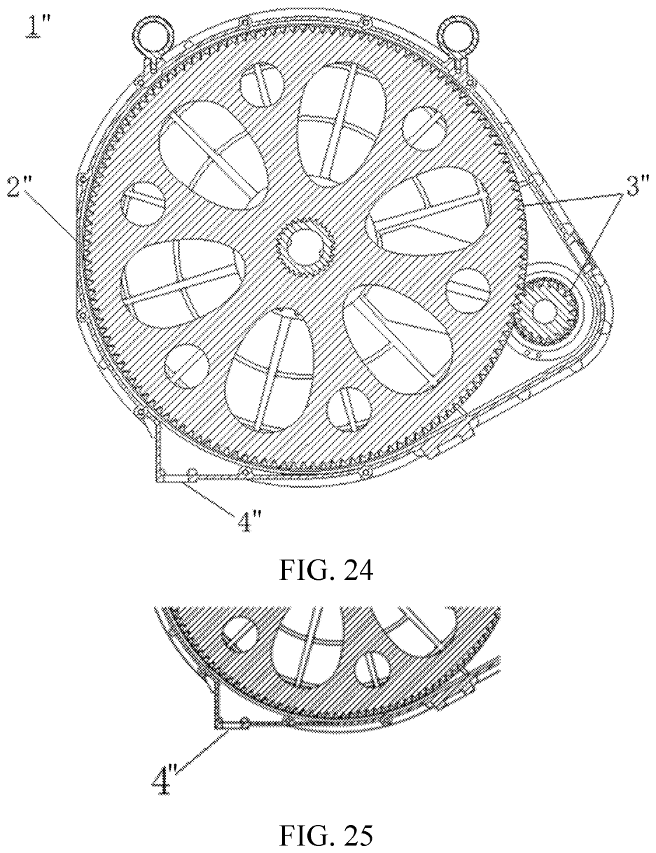

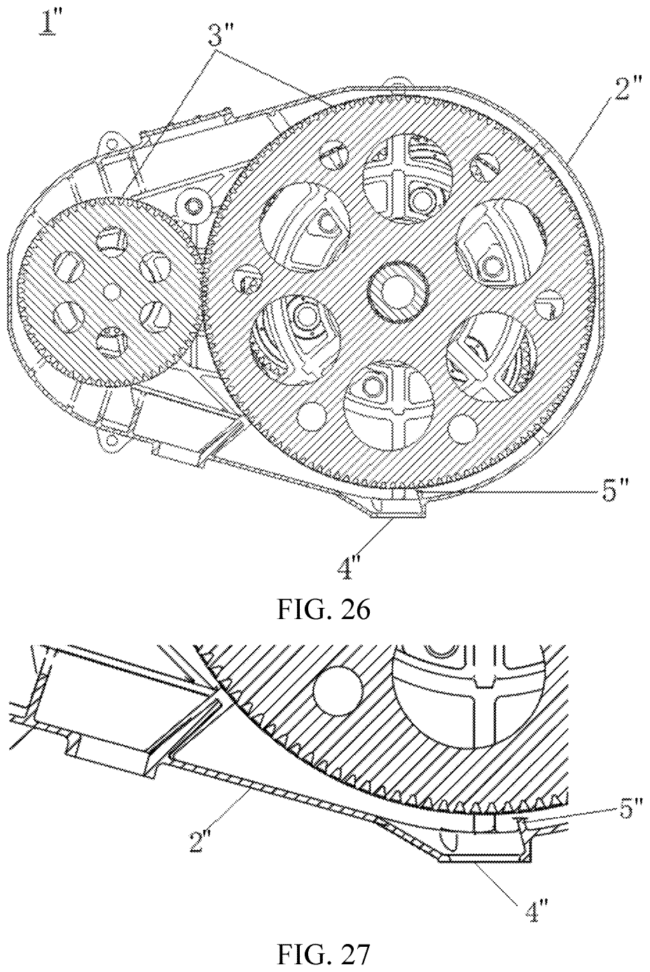

Referring to the accompanying drawing, FIG. 23 is a schematic diagram of a reduction gearbox according to another example of the present disclosure, showing an oil return port that is entirely sunken. FIG. 24 is a schematic diagram of a reduction gearbox according to another example of the present disclosure, showing an oil return port that is partially sunken. FIG. 25 is an enlarged view of the oil return port that is partially sunken in FIG. 24. FIG. 26 is a schematic diagram of a reduction gearbox according to another example of the present disclosure, showing an oil return port that is partially sunken. FIG. 27 is an enlarged view of the oil return port that is partially sunken in FIG. 26. FIG. 23 shows an example in which two oil return ports 4″ at a bottom of a reduction gearbox 1″ and a wall of a bottom of a box body 2″ are entirely sunken relative to the box body 2″. As shown in FIG. 23, the two oil return ports 4″ are arranged at the lower flat portion D of the box body 2″, namely, arranged on the wall of the bottom of the box body 2″. The wall of the bottom of the box body 2″ provided with the two oil return ports 4″ are entirely sunken here. Specifically, the position of the wall of the bottom of the box body 2″ is lower than the position when both the lower side of the left circular-arc portion A of the box body 2″ and the lower side of the right circular-arc portion B of the box body 2″ form the tangent connection. In other words, the wall of the bottom of the box body 2″ provided with the two oil return ports 4″ protrudes out of the lower side of the left circular-arc portion A of the box body 2″ and the lower side of the right circular-arc portion B of the box body 2″ toward the outside of the box body 2″, so as to extend a distance between the gear apparatus 3″ and the wall of the bottom of the box body 2″, particularly, between the gear apparatus 3″ and the oil return ports 4″, to make a larger space for the lubricating oil to flow. FIG. 24 and FIG. 25 show an example in which the oil return port 4″ is partially sunken. Namely, the oil return port 4″ is sunken relative to the box body 2″ only near the oil return port 4″. As shown in FIG. 24 and FIG. 25, the oil return port 4″ is arranged at a bottom of one side of the box body 2″, namely, arranged on a wall of a bottom of the box body 2″. The oil return port 4″ is partially sunken relative to the box body 2″ near the oil return port 4″. Specifically, the oil return port 4″ protrudes toward the outside of the box body 2″ relative to the wall of the box body 2″, so as to extend a distance between the gear apparatus 3″ and the oil return port 4″, to make a larger space for the lubricating oil to flow. FIG. 26 and FIG. 27 show another example in which the oil return port 4″ is partially sunken. In this example, the oil return port 4″ is arranged at a bottom of one side of the box body 2″ too, and an oil baffle plate 5″ is further shown. Namely, the sunken design of the oil return port 4″ may be combined with the design of the oil baffle plate 5″.

A sinking height of the oil return port 4″, namely, a height at which the oil return port 4″ protrudes out of the wall of the box body 2″ to the outside of the box body 2″, is related to factors such as speeds of the gears, a lubricating oil amount, and a distance between addendum circles of the gears and an inner wall of the box body 2″. Restricted by the arrangement space of the oil return pipe of the entire machine, the sinking height of the oil return port 4″ is usually 1 to 5 times of the wall thickness of the box body 2″. For the partially sunken design of the oil return port 4″, preferably, the oil return port 4″ is partially sunken within an oil return port area using a center of the oil return through hole 6″ as a circle center and using a value 1 to 3 times of the wall thickness of the box body 2″ as a diameter. A transition portion for steady transitioning in a throwing direction of the lubricating oil is provided between a sunken portion and a housing of the box body 2″, namely, a portion between the sunken portion and the housing of the box body 2″ needs to be steadily transitioned in the throwing direction of the lubricating oil. An angle between the transition portion and a tangential direction of an addendum circle of the gear apparatus 3 is 0 to 20°. The transition portion can use a plane, a slope, an arc surface, or any structure that can achieve stable flowing of the lubricating oil.

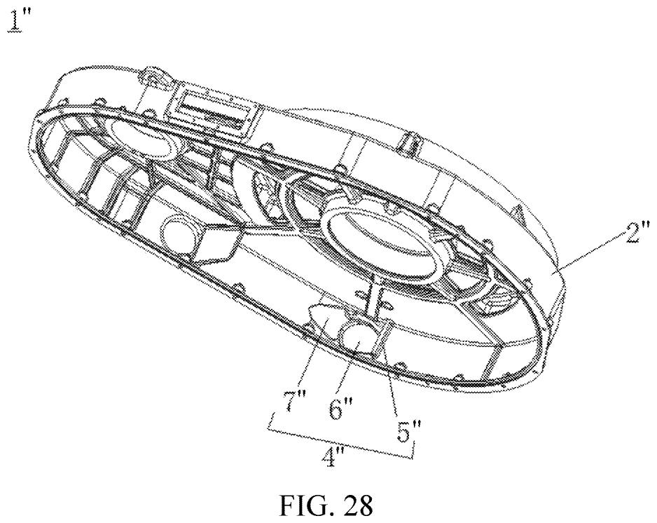

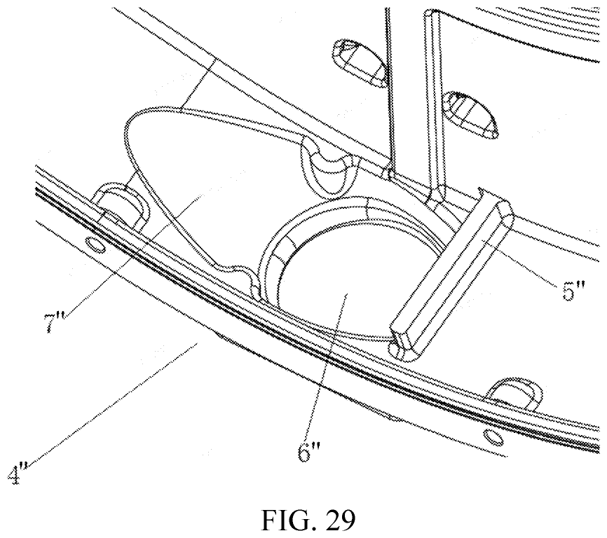

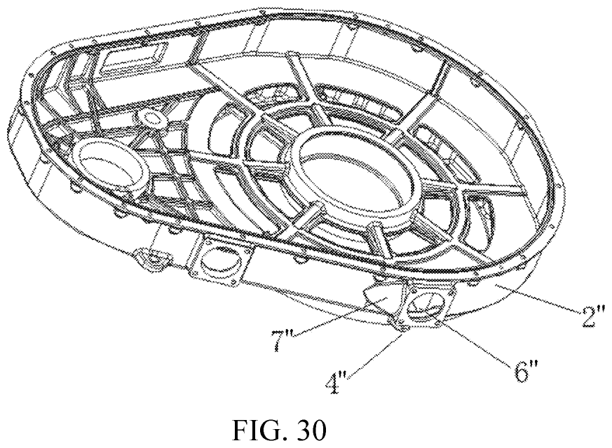

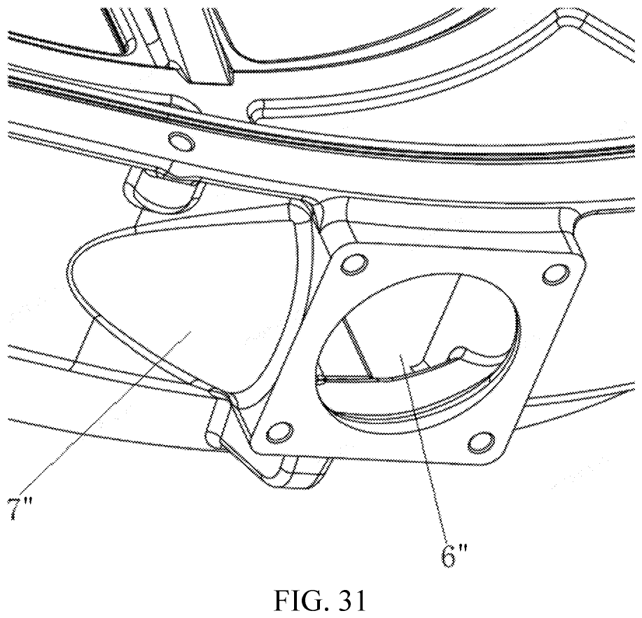

A connection mode between the box body 2″ and the sunken oil return port 4″ is not limited. It may be planar connection or cambered connection, for example, irregular cambered connection. A start range, an extension range, and a tilting angle of a cambered surface are not limited, as long as it ensures a uniform change in the wall thickness and slow corner transitioning. It should be noted that, the cambered surface here is a cambered surface that is sunken downward from a surface, to ensure smooth flowing of the lubricating oil. For example, the present disclosure provides an implementation form of the irregular cambered connection, namely, cambered transition is used. Referring to the accompanying drawings, FIG. 28 is a schematic diagram of a reduction gearbox according to another example of the present disclosure, showing an oil return port that is seen from the inside of a box body of the reduction gearbox. FIG. 29 is an enlarged view of the oil return port in FIG. 28. FIG. 30 is a schematic diagram of the reduction gearbox of FIG. 28, showing an oil return port that is seen from the outside of the box body of the reduction gearbox. FIG. 31 is an enlarged view of the oil return port in FIG. 30. As shown in FIG. 28 to FIG. 31, the oil return port 4″ of the reduction gearbox 1″ has an oil baffle plate 5″, an oil return through hole 6″, and a cambered transition portion 7″. The oil baffle plate 5″ and the cambered transition portion 7″ are arranged at two opposite sides of the oil return through hole 6″, and the cambered transition portion 7″ guides the lubricating oil to the oil return through hole 6″. Namely, the lubricating oil from the inside of the box body 2″ flows into the oil return through hole 6″ via the cambered transition portion 7. The oil baffle plate 5″ protrudes out of a wall of a bottom of the box body 2″ toward the inside of the box body 2″ to block the lubricating oil from being stirred, namely, to prevent a phenomenon that the lubricating oil cannot be smoothly discharged from the oil return port 4″ because the lubricating oil splashes forwards due to its inertia during high-speed rotation of gears. For example, the cambered transition portion 7″ has a smooth cambered surface that is sunken downward from a surface, facing the inside of the box body, of a wall of the box body 2″ and has a shape of a cup-like cambered surface. An end portion of the cambered transition portion 7″ adjacent to the oil return through hole 6″ is wider than an end portion opposite to the end portion adjacent to the oil return through hole 6″, and is sunken more deeply. A sinking depth of the cambered transition portion 7″ gradually increases from one end connected to the wall of the bottom of the box body 2 to one end connected to the oil return through hole 6″, to form a smooth cambered surface, thereby forming a gentle fall. In this way, the cup-like cambered transition of the oil return port 4″ can play a role of guiding and collecting oil, and the lubricating oil can be guided to be quickly discharged through the gentle fall.

Although the oil return through hole 6″ is circular in the accompanying drawing, this is not restrictive. The oil return through hole 6″ may alternatively be any shape satisfying an oil discharge requirement such as a polygon or an ellipse. In addition, a cross section of an oil return port mounting platform is not limited to a regular rectangle or circle, and the oil return port mounting platform may alternatively be a non-uniform table or column with a non-equal cross section, or the stiffness of the oil return port is ensured only by irregular stacking of a local material for thickening. Bolt holes connected to an oil return pipe are not limited to being arranged at four corners of the rectangle shown in the figure. A quantity and arrangement orientation of threaded holes are not limited. The threaded holes are arranged along an edge of the oil return port mounting platform, or are arranged along a circumference, or are staggered, as long as connection and fixing of the oil return pipe can be achieved. The oil return through hole may be directly formed by casting or machining.

The invention has the following beneficial effects:

According to the present disclosure, the distance between the oil return port and the addendum circle is prolonged, which facilitates the settlement and discharging of the lubricating oil. The cup-like cambered transition can guide the lubricating oil to be quickly discharged under the gravity through the gentle fall, so that the lubricating oil can be smoothly discharged, which improves the overall functionality of the reduction gearbox.

The above descriptions are merely the embodiments of the present disclosure and are not intended to limit the present disclosure. Those skilled in the art can make various changes and modifications to the present disclosure. Any modification, equivalent replacement, and improvement made within the spirit and principle of the present disclosure shall fall within the scope of the claims of the present disclosure.

What is claimed is:

1. A box body of a reduction gearbox, comprising:
an input side box body (2), wherein
the input side box body is provided with a first bearing pedestal (20), a second bearing pedestal (20), and a plurality of radial ribbed slabs (5), the plurality of radial ribbed slabs (5) comprising a plurality of first radial ribbed slabs (5) and a plurality of second radial ribbed slabs (5),
the first radial ribbed slabs (5) radially extend outward from a circle center of the first bearing pedestal (20) and the second radial ribbed slabs (5) radially extend outward from a circle center of the second bearing pedestal (20), and
a direction from the circle center of the first bearing pedestal (20) to the circle center of the second bearing pedestal (20) is a first direction and a second direction is perpendicular to the first direction;
a lateral box body (3); and
an output side box body (4), wherein
the input side box body (2) and the output side box body (4) are connected to the lateral box body (3) through a plurality of bolts (9) arranged along the lateral box body (3), wherein the radial ribbed slabs (5) are connected to the bolts (9), and
by using the circle center of the first bearing pedestal (20) as a center, in a region deviating from the second direction by a pressure angle of ±30°, the first radial ribbed slabs (5) and the bolts (9) are arranged more densely than in an another region and the pressure angle is a pressure angle of a pressure on the first bearing pedestal (20).

2. The box body according to claim 1, wherein in the region, an angle between the first radial ribbed slabs (5) is 15° to 25°.

3. The box body according to claim 1, wherein built-in oil paths integrally formed with the box body are arranged in the radial ribbed slabs (5) forming an angle of 0° to 30° with the second direction.

4. The box body according to claim 1, wherein two side surfaces of the radial ribbed slabs (5) are arranged in parallel or a distance between the two side surfaces gradually decreases towards the lateral box body (3), the two side surfaces being perpendicular to a surface of the input side box body (2).

5. The box body according to claim 1, wherein
a connection point between each first radial ribbed slab (5) and the first bearing pedestal (20) is a first connection point,
a height from the first connection point to a surface of the box body is a first height; a connection point between the first radial ribbed slab (5) and each bolt (9) is a second connection point,
a height from the second connection point and the surface of the box body is a second height, and
a third height from the first radial ribbed slab (5) to the surface of the box body is calculated by at least one of the following:
when a difference between the first height and the second height is less than or equal to 5 mm, the third height is a smaller value of the first height and the second height;
when a difference between the first height and the second height is greater than 5 mm and less than or equal to 20 mm, the third height is the first height between the first connection point and a turning point, and a top surface of the first radial ribbed slab (5) tilts relative to the input side box body (2) between the turning point and the second connection point, so that the third height linearly decreases from the first height to the second height, wherein the turning point is located between the first connection point and the second connection point; and
when a difference between the first height and the second height is greater than 20 mm, the top surface of the first radial ribbed slab (5) tilts relative to the input side box body (2), so that the third height linearly decreases from the first height to the second height.

6. The box body according to claim 1, further comprising a plurality of peripheral ribbed slabs (6), wherein
the plurality of peripheral ribbed slabs (6) intersect with the radial ribbed slabs (5) and connect the plurality of radial ribbed slabs (5) to each other,
the peripheral ribbed slabs (6) are configured to vertically intersect with the radial ribbed slabs (5), or
the peripheral ribbed slabs (6) are configured to surround the circle center of the first bearing pedestal (20) and the circle center of the second bearing pedestal (20) along the lateral box body (3).

7. The box body according to claim 1, further comprising a horizontal ribbed slab (7), wherein
the horizontal ribbed slab (7) is arranged in a region between two tangent lines of the first bearing pedestal (20) and the second bearing pedestal (20), and
the horizontal ribbed slab (7) comprises a first horizontal ribbed slab (7) and a second horizontal ribbed slab (7), the first horizontal ribbed slab (7) being located on a connection line between the circle center of the first bearing pedestal (20) and the circle center of the second bearing pedestal (20), the second horizontal ribbed slab (7) being symmetrically arranged by using the first horizontal ribbed slab (7) as a reference.

8. The box body according to claim 1, further comprising a plurality of axial ribbed slabs (12), wherein
the axial ribbed slabs (12) are arranged inside the lateral box body (3) and are perpendicular to the input side box body (2) and the output side box body (4), and wherein
one end of each axial ribbed slab (12) is connected to each bolt (9) and the other end is connected to each radial ribbed slab (5) through a turning ribbed slab (13), the turning ribbed slab (13) being located at a connection position between the lateral box body (3) and the output side box body (4).

9. The box body according to claim 1, wherein mating faces between the input side box body (2) or the output side box body (4) and the lateral box body (3) comprises sealing structures, wherein the sealing structures at least comprise sealing members (15).

10. The box body according to claim 1, wherein a cross section of each radial ribbed slab (5) is rectangular.

11. The box body according to claim 1, wherein a thickness of each second radial ribbed slab (5) is 2 to 5 times of a thickness of the output side box body (4).

12. The box body according to claim 1, wherein by using the circle center of the second bearing pedestal (20) as a center, in the region deviating from the second direction by the pressure angle of ±30°, the second radial ribbed slabs (5) and the bolts (9) are arranged more densely than in the another region.

13. A box body of a reduction gearbox, comprising:
an input side box body (2), wherein the input side box body (2) is provided with a first bearing pedestal (20), a second bearing pedestal (20), and a plurality of peripheral ribbed slabs (6);
a lateral box body (3), wherein
in a direction from a circle center of the first bearing pedestal (20) to an outer peripheral edge of the lateral box body (3), the input side box body (2) is formed into a step-like structure having a plurality of step portions (16), and wherein
the peripheral ribbed slabs (6) are at least partially formed on the step portions (16), and are configured to:
surround the circle center of the first bearing pedestal (20) or a circle center of the second bearing pedestal (20), or
surround the circle center of the first bearing pedestal (20) and the circle center of the second bearing pedestal (20) along the lateral box body (3); and
an output side box body (4), wherein the input side box body (2) and the output side box body (4) are connected to the lateral box body (3) 14. The box body according to claim 13, wherein a height of each step portion (16) is 0.5 to 2 times of a thickness of the input side box body (2).

15. The box body according to claim 13, wherein spacings between the step portions (16) are equal to each other or different from each other.

16. The box body according to claim 13, further comprising a plurality of radial ribbed slabs (5), wherein
the radial ribbed slabs (5) extend radially outward from the circle center of the first bearing pedestal (20) and intersect with the peripheral ribbed slabs (6), and
the radial ribbed slabs (5) are alternately formed by horizontal planes (51) and inclined planes (52), wherein the horizontal planes (51) are parallel to an extension plane of the output side box body (4) and the inclined planes (52) are formed on planes where the step portions

(16) intersect with the extension plane.

17. The box body according to claim 13, wherein openings (10) are provided in regions surrounded by the peripheral ribbed slabs (6) and a plurality of radial ribbed slabs (5).

18. A box body of a reduction gearbox, comprising:
an input side box body (2), wherein
the input side box body (2) is provided with a first bearing pedestal (20), a second bearing pedestal (20), and a plurality of vertical ribbed slabs (8), and in a direction from a circle center of the first bearing pedestal (20) to a circle center of the second bearing pedestal (20), the input side box body (2) is formed into a step-like structure having a plurality of first step portions (16), and wherein
the vertical ribbed slabs (8) are formed on a connection line perpendicular to the circle center of the first bearing pedestal (20) and the circle center of the second bearing pedestal (20), and are at least partially formed on the first step portions (16);
a lateral box body (3), and
an output side box body (4), wherein the input side box body (2) and the output side box body (4) are connected to the lateral box body (3).

19. The box body according to claim 18, further comprising a plurality of bolts (9), wherein the bolts (9) are arranged along the lateral box body (3) and connect the input side box body (2) and the output side box body (4) to the lateral box body (3), the bolts (9) being connected to the vertical ribbed slabs (8).

20. The box body according to claim 18, wherein a third bearing pedestal (20), a fourth bearing pedestal (20), and a plurality of peripheral ribbed slabs (6) are arranged on the output side box body (4), wherein
the third bearing pedestal (20) is opposite to the first bearing pedestal (20), and the fourth bearing pedestal (20) is opposite to the second bearing pedestal (20), wherein
in a direction from a circle center of the fourth bearing pedestal (20) to a circle center of the third bearing pedestal (20), the output side box body (4) is formed into a step-like structure having a plurality of second step portions (16), wherein
the peripheral ribbed slabs (6) are at least partially formed on the second step portions (16) and wherein
the peripheral ribbed slabs (6) are configured to surround the circle center of the third bearing pedestal (20) or the circle center of the fourth bearing pedestal (20), or surround the circle center of the third bearing pedestal (20) and the circle center of the fourth bearing pedestal (20) along the lateral box body (3).
